(19) United States
(12) Patent Application Publication
(10) Pub. No.: US 2016/0260328 A1
(43) Pub. Date: Sep. 8, 2016

(54) Real-time Occupancy Mapping System for Autonomous Vehicles

(71) Applicant: QUALCOMM Incorporated, San Diego, CA (US)

(72) Inventors: Lalan Jee Mishra, San Diego, CA (US); Richard Dominic Wietfeldt, San Diego, CA (US); Joseph Czompo, San Jose, CA (US)

(21) Appl. No.: 14/640,144

(22) Filed: Mar. 6, 2015

(51) Int. Cl. G08G 1/16; G01S 5/02; G01S 5/00; G05D 1/00; G01S 19/51

(52) U.S. Cl. CPC G08G 1/163; G05D 1/0088; G08G 1/166; G01S 19/51; G01S 5/0072; G01S 5/0284

(57) ABSTRACT

Methods, devices, systems, and non-transitory process-readable storage media for a computing device of an autonomous vehicle to generate real-time mappings of nearby vehicles. An embodiment method executed by a computing device may include operations for obtaining origin point coordinates via a first satellite-based navigation functionality, obtaining termination point coordinates via a second satellite-based navigation functionality, calculating a unit vector based on the obtained origin point coordinates and the obtained termination point coordinates, identifying a position, a direction, and an occupancy of the autonomous vehicle based on the obtained origin point coordinates, the calculated unit vector, and stored vehicle dimensions data (e.g., length, width, height), and transmitting a message using DSRC with the origin point coordinates, the stored vehicle dimensions data, and data for identifying the vehicle's direction. The computing device may compare the direction, position, and occupancy to data of nearby vehicles based on incoming messages received via DSRC.

### BACKGROUND

Autonomous vehicles (e.g., self-driving automobiles, etc.) may be configured to travel on various publicly-accessible roadways. Efficient and accident-free navigation of such autonomous vehicles requires accurate, real-time assessments of nearby objects (i.e., “occupancy mappings”). For example, real-time detection of adjacent vehicles and/or people may be required to avoid collisions or injuries. Conventional techniques for autonomous navigation often use complex approaches, such as using LiDAR, radar, and/or other sensors to detect nearby objects. As another example, some self-driving cars may require at least the use of a high-end LiDAR sensor adequate for accurate occupancy mapping. Other techniques require particular operating environments, such as smart roads with embedded elements (e.g., sensors (RF IDs) or magnets). However, these conventional techniques are typically difficult to deploy on a wide scale, as special roadways and/or high-end sensors are costly to build, install, and maintain. Further, conventional techniques may also be functionally limited, as RF, laser, or light-based techniques require line-of-sight that is often obstructed due to large trucks, etc. For example, due to the lower height of an autonomous car, laser or radar beams from the car may encounter obstructions (e.g., a tall 18-wheeler truck, etc.) that prevent producing accurate occupancy maps.

### SUMMARY

Various embodiments provide methods, devices, systems, and non-transitory process-readable storage media for a computing device of an autonomous vehicle to generate real-time mappings of nearby autonomous vehicles using dedicated short-range communications (DSRC). An embodiment method executed by the computing device of the autonomous vehicle may include operations for obtaining origin point coordinates via a first satellite-based navigation functionality, obtaining termination point coordinates via a second satellite-based navigation functionality, calculating a unit vector based on the obtained origin point coordinates and the obtained termination point coordinates, identifying a first position, a first direction, and a first occupancy of the autonomous vehicle based on the obtained origin point coordinates, the calculated unit vector, and stored vehicle dimensions data, wherein the stored vehicle dimensions data may include a length measurement and a width measurement of the autonomous vehicle, and transmitting a message using the DSRC that may include the obtained origin point coordinates, the stored vehicle dimensions data, and data for identifying the first direction of the autonomous vehicle. In some embodiments, the stored vehicle dimensions data may include a height measurement of the autonomous vehicle.

In some embodiments, the method may further include identifying relative positions of a center point of the autonomous vehicle, the first satellite-based navigation functionality, and the second satellite-based navigation functionality, and offsetting the obtained origin point coordinates and the obtained termination point coordinates based on the identified relative positions of the center point of the autonomous vehicle, the first satellite-based navigation functionality, and the second satellite-based navigation functionality. In such embodiments, identifying the first position and the first occupancy of the autonomous vehicle may be based on the offset obtained origin point coordinates. In some embodiments, the data for identifying the first direction of the autonomous vehicle may include the unit vector or the obtained termination point coordinates.

In some embodiments, the method may further include receiving an incoming message from a nearby autonomous vehicle via the DSRC, obtaining nearby autonomous vehicle origin point coordinates, nearby autonomous vehicle dimensions data, and data for identifying an orientation of the nearby autonomous vehicle from the received incoming message, identifying a second position, a second direction, and a second occupancy of the nearby autonomous vehicle based on the obtained data from the received incoming message, determining whether any navigational conditions exist based on a comparison of the first position, the first direction, and the first occupancy of the autonomous vehicle and the second position, the second direction, and the second occupancy of the nearby autonomous vehicle, and re-configuring an autonomous control parameter in response to determining that a navigational condition exists. In some embodiments, the method may further include transmitting, by the computing device using the DSRC, a response message indicating the identified navigational condition. In some embodiments, the navigational condition may be a risk of a collision between the autonomous vehicle and the nearby autonomous vehicle. In some embodiments, re-configuring the autonomous control parameter in response to determining that the navigational condition exists may include adjusting one or more of a traversal path, a speed, and an application of brakes of the autonomous vehicle.

In some embodiments, the method may further include determining whether a signal strength of the incoming message exceeds a predefined threshold, and obtaining the nearby autonomous vehicle origin point coordinates, the nearby autonomous vehicle dimensions data, and the data for identifying the orientation of the nearby autonomous vehicle from the received incoming message may include obtaining the nearby autonomous vehicle origin point coordinates, the nearby autonomous vehicle dimensions data, and the data for identifying the orientation of the nearby autonomous vehicle from the received incoming message in response to determining that the signal strength of the incoming message exceeds the predefined threshold.

In some embodiments, the method may further include determining whether the nearby autonomous vehicle is outside a relevance range threshold based on the comparison, and determining whether any navigational conditions exist based on the comparison of the first position, the first direction, and the first occupancy of the autonomous vehicle and the second position, the second direction, and the second occupancy of the nearby autonomous vehicle may include determining whether any navigational conditions exist based on the comparison of the first position, the first direction, and the first occupancy of the autonomous vehicle and the second position, the second direction, and the second occupancy of the nearby autonomous vehicle in response to determining that the nearby autonomous vehicle is within the relevance range threshold. In some embodiments, the method may further include adjusting the relevance range threshold based on the re-configured autonomous control parameter.

Further embodiments include a computing device configured with processor-executable instructions for performing operations of the methods described above. Further embodiments include a non-transitory processor-readable medium on which is stored processor-executable instructions configured to cause a computing device to perform operations of the methods described above. Further embodiments include a communication system including a computing device configured with processor-executable instructions to perform operations of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a system block diagram of a communication system including autonomous vehicles according to various embodiments.

FIG. 2A is a component block diagram illustrating a unit vector based on an origin point and a termination point corresponding to two satellite-based navigation system antennas in an autonomous vehicle according to various embodiments.

FIG. 2B is a perspective diagram illustrating exemplary locations within a bounding box corresponding to the dimensions of an autonomous vehicle according to various embodiments.

FIGS. 2C-2D are diagrams illustrating exemplary calculations that may be performed by a computing device of an autonomous vehicle to identify unit vectors based on global coordinates corresponding to two satellite-based navigation system according to various embodiments.

FIG. 2E is a component block diagram illustrating an exemplary structure of a message that may be transmitted by an autonomous vehicle via dedicated short-range communications (DSRC) according to some embodiments.

FIG. 3 is an overhead view illustrating a plurality of autonomous vehicles transmitting dedicated short-range communications that may be used to identify position, orientation, and occupancy data according to various embodiments.

FIG. 4 is a process flow diagram illustrating an embodiment method for a computing device within an autonomous vehicle to transmit dedicated short-range communications that indicate unit vectors based on two global coordinate sets.

FIG. 5 is a process flow diagram illustrating an embodiment method for a computing device within an autonomous vehicle to receive and process dedicated short-range communications from nearby autonomous vehicles that indicate unit vectors based on two global coordinate sets.

FIG. 6 is an overhead view illustrating a plurality of autonomous vehicles within a dedicated short-range communications relevance range of a first autonomous vehicle according to various embodiments.

FIG. 7 is a process flow diagram illustrating an embodiment method for a computing device within an autonomous vehicle to process dedicated short-range communications that indicate unit vectors based on two global coordinate sets and that are received within a relevance range threshold from nearby autonomous vehicles.

FIG. 8 is a component block diagram of a computing device within an autonomous vehicle suitable for use in various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The word “exemplary” is used herein to mean “serving as an example, instance, or illustration.” Any implementation described herein as “exemplary” is not necessarily to be construed as preferred or advantageous over other implementations.

The term “computing device” is used herein to refer to electronic devices having at least a processor, such as computers integrated within a vehicle, particularly an autonomous vehicle, but may also include mobile communication devices (e.g., any one or all of cellular telephones, smart-phones, web-pads, tablet computers, Internet enabled cellular telephones, laptop computers, etc.), servers, personal computers, etc. configured to communicate with an autonomous vehicle. In various embodiments, a computing device may be configured with one or more network transceivers or interfaces for establishing communications with other devices. For example, computing devices may include a network interface for establishing a wide area network (WAN) connection (e.g., a Long-Term Evolution cellular network connection, etc), a short-range wireless connection (e.g., a Bluetooth®, RF, etc.), and/or a local area network (LAN) connection (e.g., a wired or wireless connection to a Wi-Fi® router, etc.).

The terms “autonomous vehicle,” “unmanned vehicle,” and “drone” are used herein to refer to various types of vehicles including automobiles that include at least a computing device configured to perform autonomous navigation through traffic and/or control various internal vehicle systems (e.g., braking, turning, accelerating, etc.). For example, an autonomous vehicle may be a self-driving car, drone, truck, etc. Autonomous vehicles may include vehicles that may be configured to operate with or without any human input regarding movement of the vehicle. Autonomous vehicles may also include unmanned aerial vehicles (or UAVs) and other unmanned vehicles that may or may not travel on the ground.

Different satellite-based coordinate delivery systems may be used within various geographical areas. For convenience, the terms “satellite-based navigation functionality,” “satellite-based navigation system,” “Global Positioning System” (GPS), and “Global Navigation Satellite System” (GNSS) may refer to any satellite-based location or global coordinate determining system for determining the coordinates of an autonomous vehicle within a global coordinate system according to the various embodiments. In other words, the use of “GPS” or similar terms herein should not be interpreted to limit the scope of the claims to any particular type of satellite-based global navigation system. For example, although the term “satellite-based navigation functionality” may be used herein to refer to equipment, software, antenna, routines, instructions, modules, and/or other components that may be used by a computing device of an autonomous vehicle to determine current location coordinates of the vehicle, any form of functionality and/or location standard, service, or coordinates platform may be used by the computing device of the autonomous vehicle.

The term “dedicated short-range communication(s)” (DSRC) is used herein to refer to wireless communications that may be used by various autonomous vehicles and/or devices configured to operate in association with a roadway, such as a street light, a street sign, etc. DSRC may refer to communications having various standards, protocols, frequencies, formats, and/or other specifications that may be used to implement vehicle-to-vehicle communications. For example, DSRC may refer to wireless communications within the spectrum of a 5.9 GHz band. The use of the term “DSRC” is not intended to limit the wireless communications that may be used by autonomous vehicles to implement the embodiment techniques described herein.

Dedicated short-range communications are currently used for communicating information relevant to autonomous vehicles, such as traffic light states or autonomous vehicle braking conditions. However, vehicle-to-vehicle communication techniques and other infrastructures necessary for efficiently supporting navigation of autonomous vehicles do not yet exist. As autonomous vehicles become used in typical public scenarios, more sufficient and cost-effective techniques are needed to ensure safety of autonomous vehicles using automated navigation.

The various embodiments provide methods, devices, systems, and non-transitory process-readable storage media for enabling low-cost, efficient mappings of orientation, position, and space-occupancy of autonomous vehicles in real-time based on data transmitted within wireless communications. In general, autonomous vehicles may be configured to periodically and frequently broadcast small amounts of data that may be used by other nearby vehicles to identify the current position, direction (or orientation), and occupied space of the broadcasting vehicles. For example, data broadcast by each autonomous vehicle may be used by recipient autonomous vehicles to identify a unit vector indicating the autonomous vehicle's current orientation, the current global position of the autonomous vehicle's center (e.g., GPS coordinates), and the dimensions of the autonomous vehicle (e.g., length, width, and height). Such broadcasts may be transmitted by each of the autonomous vehicles via conventional DSRC (or vehicle-to-vehicle communications). Using the data of the broadcasts, recipient autonomous vehicles may quickly identify whether the operations of the recipient autonomous vehicles should be adjusted or re-configured based on other how and where the broadcasting vehicles are on the roadway. For example, based on a received DSRC message indicating the front of a first autonomous vehicle is turned into a lane and is within a hazardously close distance, a second autonomous vehicle may cause the brakes of the second autonomous vehicle to be applied, the speed of the second autonomous vehicle to be slowed, and/or a maneuver to be applied (e.g., a quick veer to the side) in order to avoid a collision with the first autonomous vehicle. In this manner, autonomous vehicles may compute relative positions and orientations of nearby cars to generate occupancy mappings that may be used for accurately and safely plotting a traversal route through traffic.

In various embodiments, an autonomous vehicle may be configured with at least a computing device, a DSRC functionality (e.g., antenna, transceiver, etc.), and two distinct, spatially separated satellite-based navigation functionalities that each provide accurate global position data (or coordinates). The satellite-based navigation functionalities may include single-antenna receiver or multi-antenna receiver configurations that continuously provide highly accurate global position data (e.g., coordinates that may be accurate within a few centimeters). For example, the autonomous vehicle may utilize a differential global positioning system (DGPS) or multi-antenna GPS signal reception and processing unit to compute coordinates within an accuracy of approximately +/−10 cm, providing an improvement of a factor of 150 over standard GPS. In some embodiments, a first satellite-based navigation functionality (e.g., GPS antenna) may be located at the center of the autonomous vehicle and a second satellite-based navigation functionality may be located at an end (e.g., front) of the autonomous vehicle.

Accurate global position data (e.g., GPS coordinates) received from the satellite-based navigation functionalities may be used by the computing device of the autonomous vehicle to calculate a vector indicating the direction of the autonomous vehicle at a given time. In particular, the computing device may calculate a unit vector using global position data from the first satellite-based navigation functionality (i.e., “origin point” coordinates) and global position data from the second satellite-based navigation functionality (i.e., “termination point” coordinates). The unit vector may be a normalized mathematical representation of the autonomous vehicle's global orientation (e.g., a rotation, a heading, etc.). In other words, the unit vector may indicate how the autonomous vehicle is pointed. Using a unit vector-based approach may provide better directional accuracy along with speed than other techniques that derive speed and orientation based on a point coordinate.

In some embodiments, the computing device may be configured to perform operations to mathematically offset origin point and termination point coordinates based on relative positions of the coordinates within the autonomous vehicle. For example, the coordinates may be transformed in three-dimensional space by an amount equal to the difference between a predefined location of the first satellite-based navigation functionality and the actual center point of a virtual bounding box that encompasses the entirety of the structure of the autonomous vehicle. With such offsetting, the origin point coordinates may represent a global position of the geometric center of the autonomous vehicle (i.e., the intersection of the three diagonals of the virtual box representing the autonomous vehicle).

In some embodiments, the computing device of the autonomous vehicle may broadcast messages via wireless DSRC that include the autonomous vehicle's origin point coordinates (e.g., a three-dimensional position vector), the calculated unit vector, and data indicating the autonomous vehicle's dimensions (e.g., length, width and height). Such broadcasts may typically be done at a 1 or 2-mS interval. Other devices within DSRC range may receive the broadcasts and compute or otherwise identify the broadcasting autonomous vehicle's orientation (or direction), global position, and occupied space using the various data in the broadcast messages. Data refreshes and broadcasts by the computing device of the autonomous vehicle may occur at a rate sufficient to ensure accurate occupancy mapping calculations for efficient and collision-free navigation. Thus, the DSRC broadcasts may enable nearby devices (e.g., adjacent autonomous vehicles) to generate orientation, position, and space-occupancy maps in real-time that may be used for various purposes, such as collision-avoidance and making accurate navigational decisions for traversing traffic. In some embodiments, the computing device may not broadcast the unit vector, but instead the origin point coordinates and the termination point coordinates in order to allow recipient autonomous vehicles to calculate the unit vector themselves.

In some embodiments, the computing device of the autonomous vehicle may be configured to limit/filter the dedicated short-range communications that are evaluated for a given time. In other words, the computing device may be configured to improve efficiency by not evaluating all DSRC messages that are received (e.g., messages indicating unit vectors), but instead only data received from other autonomous vehicles that are within a predefined relevance range. Such ranges may be distances that are calculated or otherwise known by the computing device to be required to generate occupancy mappings sufficient for navigation. For example, as dedicated short-range communications (DSRC) may be received up to a mile away from a transmitting autonomous vehicle, the computing device of the autonomous vehicle may ignore communications from other autonomous vehicles that are not close enough to pose any danger of collision. In some embodiments, the computing device may filter out communications (e.g., set an area of relevance/irrelevance) outside of a boundary or zone based on various factors, such as traffic conditions, GPS data, speed of travel, etc.

In some embodiments, the computing device of the autonomous vehicle may be configured to use calculated movement information to check the accuracy of received position data via the two satellite-based navigation functionalities associated with the autonomous vehicle. For example, the computing device may calculate two speed values based on coordinates received via each of the satellite-based navigation functionalities and determine whether the speed values are within a predefined tolerance threshold in order to check the accuracy of the two functionalities. Such checks may include storing at least previously received position data for each satellite-based navigation functionality that may be used with current position data for each satellite-based navigation functionality to calculate associated speeds at the current time.

In some embodiments, when satellite reception is not available and thus the computing device is unable to receive origin point or termination point coordinates to generate unit vectors, the computing device may utilize other data sources to temporarily supplement navigational operations or occupancy mappings. For example, while traveling within a tunnel that prevents GPS satellite reception, the computing device may utilize data from expensive sensors (e.g., LiDAR, etc.) and/or inexpensive sensors (e.g., cameras, microphones, ultrasound, etc.) in order to gather data for processing by navigational routines.

Unavailability of satellite signals and/or inaccurate calculations may cause problems for groups of autonomous vehicles. For example, a global navigation satellite system (GNSS) may provide inaccurate position data (e.g., data having a large position error) that may cause car collisions due to the occupancy calculations using that position data. To provide safeguards that may further ensure accuracy and improve safety, the computing device within the autonomous vehicle may be configured to determine whether there is sufficient satellite (e.g., GPS or GNSS) availability to compute an accurate position in some embodiments. Such determinations may be made based on signal strengths measured by satellite-based navigation functionalities (e.g., GPS/GNSS receivers) and/or on a number of satellites contributing global position data at a given time (e.g., minimum 3 satellites for a position, minimum 4 satellites for a position and a time, etc.). When there is insufficient satellite availability based on such determinations (e.g., the number of observed satellites or “space vehicles” (SV) is below a predefined threshold, etc.), the computing device of the autonomous vehicle may perform various actions, such as displaying and/or transmitting messages indicating that there is currently no position found (e.g., an “N/A Position”).

Although not used broadly in typical satellite-based location systems (e.g., GNSS systems), “integrity support messages” (ISMs) may be utilized in the future with regard to satellite navigation systems, such as Galileo and GPS. Accordingly, in some embodiments, the computing device of the autonomous vehicle may be configured to utilize ISMs received from various satellites for determining the suitability of global position data received via the autonomous vehicle's satellite-based navigation functionalities (e.g., GPS/GNSS receivers). Such messages may indicate which SVs are dysfunctional at a given time and thus should not be trusted by the computing device for providing accurate position data. The ISMs may be sent within each SV broadcast stream to all ground receivers (i.e., the satellite-based navigation functionalities of the autonomous vehicle), or may be sent from other entities, such as a Wide Area Augmentation System (WAAS) satellite. The computing device (e.g., via the satellite-based navigation functionalities or receivers associated with the autonomous vehicle) may be configured to receive the ISMs and remove data associated with the identified SVs (e.g., failed satellites) from position determinations. For example, the computing device may only calculate origin point coordinates based on signals received from satellites that have not been reported as malfunctioning. As another example, based on ISMs, the computing device may determine that there are insufficient SVs to reliably compute an accurate position even though a received GPS signal may have a received strength indicator (RSSI) within an acceptable range.

In some embodiments, the computing device of the autonomous vehicle may include error calculations (e.g., position errors) within DSRC broadcast messages. For example, the computing device may insert confidence or error probability data within DSRC transmissions. Nearby autonomous vehicles receiving the messages may use any such error information to adjust calculations by the nearby autonomous vehicles of the position, orientation, and occupancy of the autonomous vehicle at a given time. In some embodiments, nearby autonomous vehicles may use various positioning service transmissions (e.g., ISMs, etc.) to compute a position error separately from any error indications received in DSRC messages from the computing device of the autonomous vehicle. Such independently calculated errors related to the autonomous vehicle may be used to adjust orientation, position, and/or occupancy calculations for the autonomous vehicle.

In some embodiments, if a position error calculated by the computing device and/or a nearby autonomous vehicle exceeds a predefined tolerance threshold, the computing device and/or the receiving device may transmit a message indicating the error (e.g., display a message to a user, etc.) and/or may discard any associated DSRC message. For example, if two large position errors are calculated by the computing device based on position data associated with two static GPS antennas of the autonomous vehicle, the computing device may recalculate data prior to transmitting DSRC messages. Alternatively, large errors received within DSRC messages or otherwise calculated by the computing device (or a computing device within an adjacent autonomous vehicle) with respect to nearby autonomous vehicles may be used to consider received data incorrect and thus to be discarded by the computing device. In some embodiments, if position errors identified by the computing device (or a computing device within an adjacent autonomous vehicle) exceed an error tolerance threshold for a defined duration (e.g., 0.1 seconds), the device identifying these errors may alert an associated driver to take some action, such as taking control of the autonomous vehicle, alerting an associated automated system to disable or modify automated actions, and/or transmitting alerts via DSRC to nearby vehicles that indicate the errors.

Conventional techniques may utilize unit vectors and/or DSRC differently than the embodiment techniques. In particular, conventional techniques may only use one GPS coordinate or GPS system. For example, conventional techniques may teach that autonomous vehicles may obtain a single position to be used with velocity data in order to calculate likely future positions of the vehicles. As another example, conventional techniques may utilize two different GPS readings at different times from a single antenna in order to calculate a speed of an autonomous vehicle. However, embodiment techniques as described herein may utilize coordinates from two satellite-based navigation functionalities (e.g., from two distinct, separately-placed GPS antenna/receivers) to calculate orientation, regardless of time, velocity, speed, or other factors. For example, with origin point coordinates and termination point coordinates, autonomous vehicle computing devices may be configured to perform embodiment operations for finding the autonomous vehicle's orientation, even if standing still (e.g., zero velocity). Further, conventional techniques may utilize various sensors, such as compasses, in order to determine headings or orientations. The embodiment techniques may not require such sensors, but instead may utilize only two sets of simultaneously-available global position data (e.g., origin point coordinates and termination point coordinates) to calculate unit vectors showing orientation.

The various embodiments provide inexpensive and efficient techniques for identifying and communicating data that may be used to adjust or control autonomous vehicle navigational routines. Utilizing two precise satellite-based navigation functionalities (e.g., GPS functionalities) and established vehicle-to-vehicle communication formats (e.g., DSRC), autonomous vehicles configured with embodiment techniques may share a small amount of essential data to allow nearby autonomous vehicles to determine position, orientation, and occupied space at a given time. The functioning of computing devices within autonomous vehicles may be improved via the embodiment techniques, as data messages transmitted by implementing computing devices may include simple data structures requiring little manipulation and thus minimal computing resources of recipient devices. For example, data packets may only include a first vector for a center position of an autonomous vehicle, a unit vector, and scalar values related to the autonomous vehicle's dimensions.

Further, as the simple data communicated in embodiment messaging may easily communicate positions, orientations, and occupied space of vehicles, autonomous vehicles may not require complex operations, costly equipment, and/or line-of-sight in order to provide effective occupancy mappings. For example, the embodiment techniques may not require specialized equipment onboard (e.g., LiDAR sensors) or within roadways (e.g., embedded sensors, etc.), but instead may only require two sources of global position data (e.g., GPS coordinates) and a wireless communication system providing DSRC functionalities. In some implementations, embodiment techniques may be utilized as complementary functionalities to existing, standard, and low-cost functionalities of modern cars (e.g., GPS sensors, DSRC modules). For example, an embodiment system may be an after-market option to enhance Advanced Driver Assistance System (ADAS) navigational decision making and collision avoidance abilities. However, those skilled in the art should also be appreciated that use of the embodiment techniques may not preclude the use of any other conventional navigational techniques and equipment (e.g., LiDAR, radar, etc.) in autonomous vehicles. In other words, the embodiment techniques may be used in combination with, in place of, and/or to supplement other navigational techniques, and vice versa. For example, when satellite-based information is unavailable, such as due to being within a tunnel, an autonomous vehicle implementing the embodiment techniques may utilize a LiDAR, cameras, and/or other expensive or inexpensive conventional sensor technique to navigate until satellite information is once again available.

In general, the embodiment techniques may utilize vehicle-to-vehicle communications (e.g., DSRC) that inherently introduce latency between transmission and receipt. However, such latencies are not likely to cause great inaccuracies with the embodiment techniques and may be factored into navigational decision making. For example, with a data communication and associated computation latency of 1 ms, distance calculations of an autonomous vehicle moving at a speed of 80 miles per hour may only include an acceptable error of approximate 3.5 centimeter/millisecond.

The following descriptions refer to position or location data (e.g., GPS data, relative positions, global positions, vectors, etc.) using rectilinear three-dimensional (3D) coordinate values (e.g., x, y, z values of a 3D Cartesian system). However, any coordinate system may be used by embodiment techniques to indicate position information (e.g., spherical coordinates, latitude/longitude, etc.).

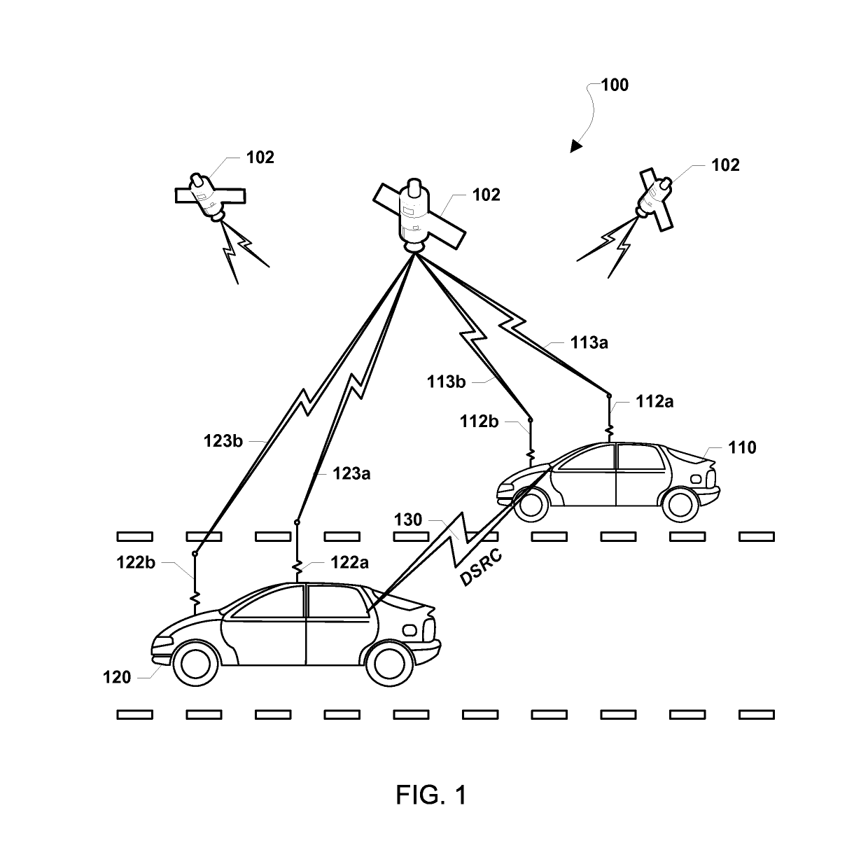

FIG. 1 illustrates a communication system 100 including autonomous vehicles usable with the various embodiments. In particular, FIG. 1 shows a first autonomous vehicle 110 equipped with a first antenna 112a and a second antenna 112b configured to receive signals 113a, 113b from a plurality of satellites 102 (e.g., three or more) in orbit above the first autonomous vehicle 110. Such signals 113a, 113b may indicate coordinates or position information for the first antenna 112a and the second antenna 112b, respectively. The antennas 112a, 112b may be used to obtain highly accurate position coordinates, and in some embodiments, may each include a plurality of antennas or other components for receiving and processing the signals 113a, 113b. In some embodiments, the satellites 102 may be associated with various satellite constellations that may be operated by or otherwise associated with different controlling entities (e.g., companies, countries, organizations, etc.). For example, the satellites 102 may be GPS satellites.

In various embodiments, the antennas 112a, 112b may be statically-installed within the first autonomous vehicle 110 so that the distance and orientation between the antennas 112a, 112b remains constant. For example, the first antenna 112a may be located near the center of the first autonomous vehicle 110 (e.g., mounted on the roof, affixed to the chassis, etc.) and the second antenna 112b may be located near the front of the first autonomous vehicle 110 (e.g., under the hood, etc.). Further, the relative position of the antennas 112a, 112b may be predefined, such as defined within stored specifications accessible to a computing device within the autonomous vehicle 110.

FIG. 1 shows the first autonomous vehicle 110 and a second autonomous vehicle 120 traveling within proximity of one another on a roadway (e.g., a highway, city street, etc.). Similar to the first autonomous vehicle 110, the second autonomous vehicle 120 may be equipped with a first antenna 122a and a second antenna 122b configured to receive signals 123a, 123b from the satellites 102 in orbit above the second autonomous vehicle 120. Such signals 123a, 123b may indicate coordinates or position information for the first antenna 122a and the second antenna 122b, respectively. The antennas 122a, 122b may be used to obtain highly-accurate position coordinates related to the second autonomous vehicle 120, and in some embodiments, may each include a plurality of antenna or other components for receiving and processing the signals 123a, 123b. Similar to the antennas 112a, 112b of the first autonomous vehicle 110, the antennas 122a, 122b of the second autonomous vehicle 120 may be statically-installed within the second autonomous vehicle 120 so that the relative distance and orientation between the antennas 122a, 122b remains constant.

Both the first autonomous vehicle 110 and second autonomous vehicle 120 may include components for conducting communications with nearby autonomous vehicles. In particular, both autonomous vehicles 110, 120 may include units for enabling dedicated short-range communications (DSRC), such as computing devices, transceivers and antenna for transmitting and receiving DSRC. With such functionalities, the first autonomous vehicle 110 and the second autonomous vehicle 120 may exchange messages via DSRC 130. For example, when within DSRC reception range, each of the autonomous vehicles 110, 120 may transmit data including individual unit vectors as described and receive the other vehicle's unit vectors while the two vehicles travel alongside each other on the roadway.

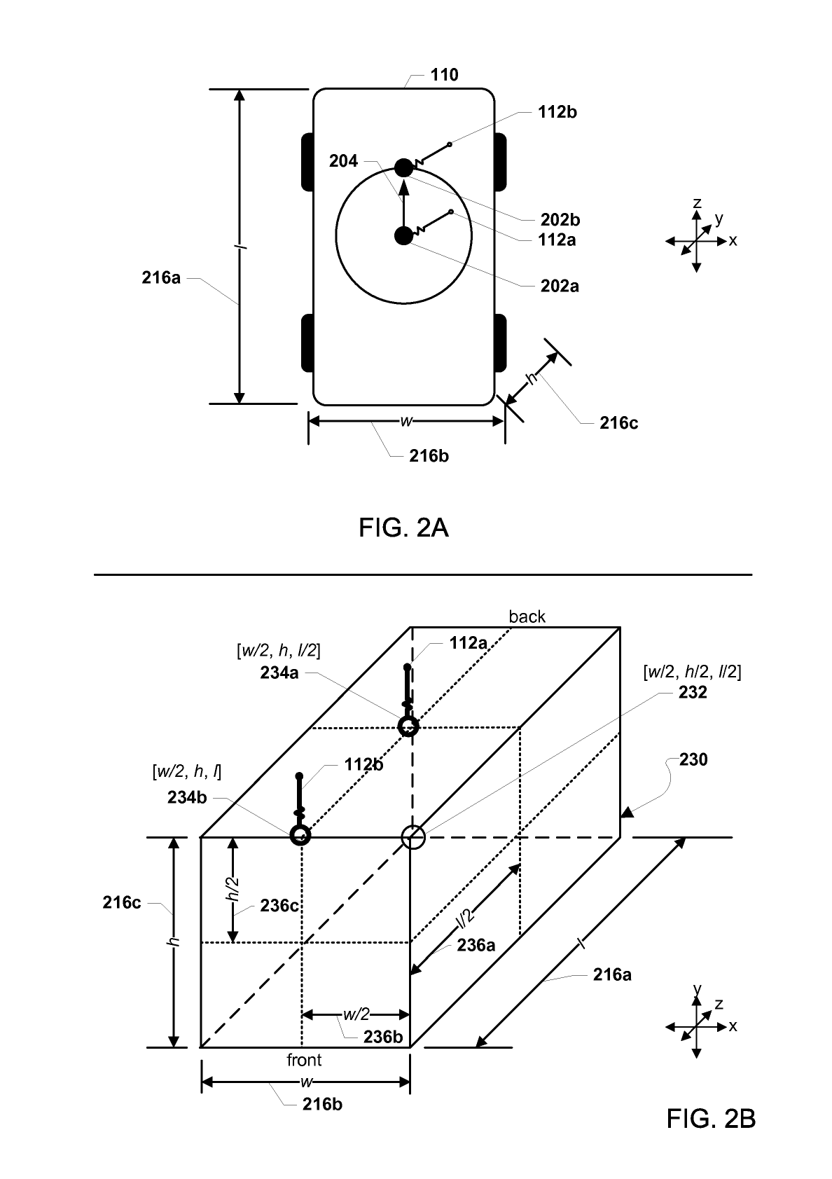

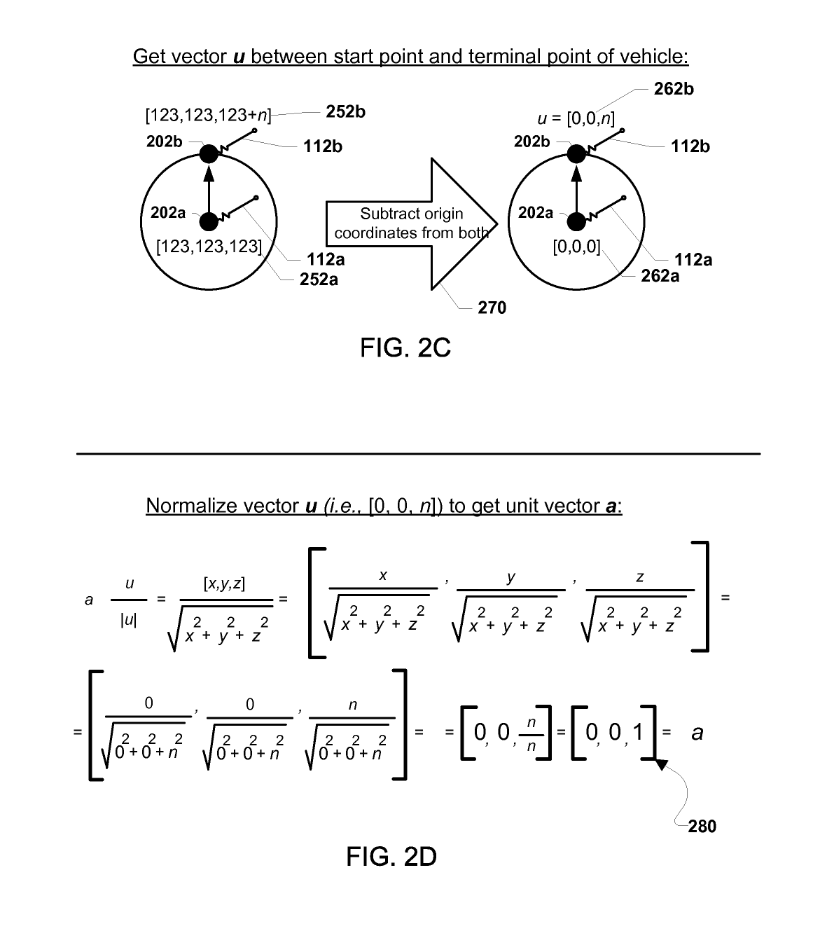

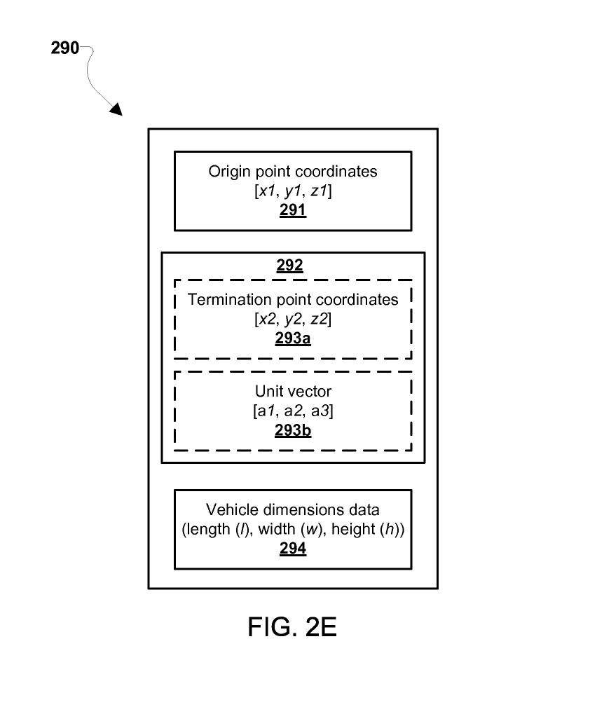

FIG. 2A illustrates an exemplary unit vector 204 that may be calculated by a computing device associated with a first autonomous vehicle (e.g., 110). With reference to FIGS. 1-2A, based on global coordinates data (e.g., GPS coordinates) received via the first antenna 112a and the second antenna 112b, the computing device may identify an origin point 202a and a termination point 202b, respectively. For example, the computing device may identify an origin point 202a corresponding to GPS coordinates of the first antenna 112a and a termination point 202b corresponding to GPS coordinates of the second antenna 112b. For instance, the origin point 202a and the termination point 202n may be aligned along the length of the autonomous vehicle 110. Such points 202a, 202b (or related coordinates) may be stored by the computing device and updated as new coordinates data is received via the antennas 112a, 112b. Further, the origin point 202a and termination point 202b (or the coordinates of the original point 202a and termination point 202b) may be used to calculate the unit vector 204. In some embodiments, the unit vector 204 may be a normalized vector that indicates the direction the first autonomous vehicle 110 is facing. Exemplary operations that may be performed by the computing device to calculate such a unit vector 204 are described (e.g., with reference to FIGS. 2B-2C).

The computing device may also be configured to store vehicle dimensions data of the autonomous vehicle 110 (or portions thereof). For example, the computing device may store a length 216a (‘l’), a width 216b (‘w’), and a height 216c (‘h’) of the autonomous vehicle 110. Such dimensions data may be pre-loaded on the computing device, such as from a manufacturer. In some embodiments, the computing device of the autonomous vehicle 110 may use the unit vector 204 along with the dimensions data to calculate position, orientation, and occupancy information of the autonomous vehicle 110. For example, the computing device may calculate three-dimensional data that represents the space occupied by the autonomous vehicle 110 at a given time by calculating extrusions using the unit vector 204 and the length 216a, width 216b, and height 216c.

In some embodiments, the computing device of the autonomous vehicle 110 may also be configured to calculate, store, or otherwise determine dimensions and occupancy data of the autonomous vehicle 110 and any attached components, such as a trailer, a towed car, etc. For example, in the case of the autonomous vehicle 110 towing a trailer, the computing device of the autonomous vehicle 110 may be configured to determine whether a trailer is connected to the autonomous vehicle 110, to identify the length, width, height of the trailer (e.g., communicate with a communication element of the trailer to receive the dimensions via wired or wireless connection, query a predefined database of dimensions data related to the trailer, etc.), and to adjust (or combine) dimensions data to be broadcast via DSRC based on the identified dimensions data of the trailer.

In various embodiments, the computing device may be configured to perform various vector coordinate transform calculations to globally place and orient virtual representations of the autonomous vehicle 110 (e.g., collision or bounding box) in order to be compared with representations of nearby vehicles. For example, the computing device may perform operations that rotate the unit vector 204 a number of degrees on an axis (e.g., +/−90 degrees for sides of the autonomous vehicle, 180 degrees for rear of autonomous vehicle, etc.), as well as that use appropriate scalars to be applied to a transformed unit vector 204 (e.g., half-lengths to find the front and back of the collision box from the origin point 202a, half-widths to find the sides of the collision box from the origin point 202a, half-heights to find the top and bottom of the collision box from the origin point 202a, etc.). In some embodiments, the computing device may identify various transforms (e.g., rotational vectors, matrices, etc.) that may be applied to relative or zeroed-out coordinates of the autonomous vehicle 110. For example, the computing device may be configured to calculate a collision box oriented to a predefined direction (e.g., true north) and calculate an oriented collision box by applying a rotational transform based on the global coordinates of the points 202a, 202b defining the unit vector 204 associated with the autonomous vehicle 110.

FIG. 2B illustrates exemplary locations within a bounding box 230 corresponding to the dimensions of an autonomous vehicle 110, such as described with reference to FIG. 2A. With reference to FIGS. 1-2B, the computing device of the autonomous vehicle 110 may calculate the bounding box 230 of the autonomous vehicle 110 in relative space (i.e., in coordinates centered on the vehicle and not global coordinates) using predefined, stored vehicle dimensions data, such as the length 216a, width 216b, and height 216c data. Further, the computing device may calculate a center point 232 based on the vehicle dimensions data, such as by finding the midpoint (or half-value) of each of the dimensions 236a-236c (e.g., width (w)÷2, length (l)÷2, height (h)÷2). The coordinates for the center point 232 (e.g., [w/2, h/2, l/2]) may be defined relative to the autonomous vehicle 110. For example, instead of indicating a global position, the center point 232 may indicate a number of centimeters, inches, feet, etc. from the center, front, back, top or bottom, and/or sides of the bounding box 230. The first antenna 112a and second antenna 112b may also be associated with coordinates relative to the bounding box 230. For example, the first antenna 112a may be fixed at a first point 234a that is in the middle of the length (w/2), in the middle of the width (w/2), but on top of the height (h). As another example, the second antenna 112b may be fixed at a second point 234b that is at the front of the bounding box 230 (l), in the middle of the width (w/2), and on top of the height (h). The center point 232 may be calculated and stored, whereas the first point 234a and second point 234b may be predefined or pre-stored within memory of the computing device.

In some embodiments, the computing device may compare the relative values of the points 232, 234a, 234b to determine offset values as described. For example, the computing device may offset origin point coordinates that indicate a global position of the first antenna 112a by the relative distance between the center point 232 and the first point 234a.

FIGS. 2C-2D illustrate exemplary calculations that may be performed by a computing device of an autonomous vehicle to identify a unit vector based on global coordinates corresponding to two GPS antenna according to various embodiments. FIG. 2C illustrates example calculations to transform a first representation 252a (i.e., the vector [123, 123, 123]) of the origin point 202a and a second representation 252b (i.e., the vector [123, 123, 123+n]) of the termination point 202b into a new representation that indicates orientation (or direction) and relative distance (n) between the points 202a-202b. With reference to FIGS. 1-2C, as described, the origin point 202a may correspond to GPS coordinates from the first antenna 112a on the autonomous vehicle 110 (e.g., a first GPS antenna or functionality), and the termination point 202b may correspond to GPS coordinates from the second antenna 112b on the autonomous vehicle 110 (e.g., a second GPS antenna or functionality). In some embodiments, the representations 252a, 252b may be 3D vectors that indicate the global x-axis, y-axis, and z-axis coordinates of the points 202a, 202b.

In order to obtain relative coordinates based on the points 202a, 202b, the computing device of the autonomous vehicle 110 may perform operations 270 to zero-out the first representation 252a, such as by subtracting the coordinates of the origin point 202a from both representations 252a, 252b. In doing so, the computing device may generate a new origin representation 262a (i.e., [0, 0, 0]) and a new termination point representation 262b (i.e., [0, 0, n]). Since the first representation 252a was “zeroed-out” by the operations 270, the new termination point representation 262b may indicate the global orientation and relative distance between the origin point 202a and the termination point 202b.

Conventional vector transformation equations may be used by the computing device to generate a unit vector (or normalized vector) based on another vector (e.g., the vector u shown in FIG. 2C). In other words, based on the origin point coordinates and termination point coordinates from two antennas (e.g., GPS antenna) of an autonomous vehicle, a computing device may identify a unit vector having a length of one (i.e., a direction vector) that indicates the global orientation of the autonomous vehicle 110. Such a unit vector may be combined with other information about the autonomous vehicle 110, such as dimensions data and origin point coordinates, to determine the autonomous vehicle's 110 global position and occupancy.

In particular, in some embodiments, the unit vector (‘a’ as referred to in FIG. 2D) may be calculated by the computing device by performing operations that use the following equation (Equation 1):

$$a = \frac{u}{\vert u \vert} = \frac{[ x , y , z ]}{\sqrt{{x}^{2} + {y}^{2} + {z}^{2}}} = [ \frac{x}{\sqrt{{x}^{2} + {y}^{2} + {z}^{2}}} , \frac{y}{\sqrt{{x}^{2} + {y}^{2} + {z}^{2}}} , \frac{z}{\sqrt{{x}^{2} + {y}^{2} + {z}^{2}}} ]$$

where u represents a three-dimensional vector (i.e., [x, y, z]), and |u| represents a length (or norm) of the u vector. FIG. 2D illustrates one simple, exemplary application of the equation listed above in which the vector u may be [0, 0, n] and n may be a length between an origin point and a termination point as shown in FIG. 2C. With reference to FIGS. 1-2D, in this case, the vector u may indicate that the origin point and the termination point are in alignment such that the x-axis and y-axis coordinates of the origin point and the termination point are the same, however the z-axis coordinates of the origin point and the termination point are separated by the length n. In other words, an autonomous vehicle corresponding to the vector u may thus be assumed to be pointed in a manner heading directly toward to a global reference point, such as pointed toward North. By applying the Equation 1 listed above to the vector u, a unit vector 280 (a) may be generated (e.g., [0, 0, 1]). In addition to showing orientation, such a unit vector 280 may be scaled using vehicle dimensions data (e.g., length, width, height values) to identify boundaries of the autonomous vehicle for collision avoidance and other purposes.

FIG. 2E illustrates an exemplary message data structure 290 of a message that may be transmitted by an autonomous vehicle (e.g., 110 in FIGS. 1-2A) via DSRC according to some embodiments. With reference to FIGS. 1-2E, based on operations, such as calculations to identify a current unit vector based on origin point and termination point coordinates from two antennas of the autonomous vehicle, a computing device of the autonomous vehicle may wirelessly transmit packets or messages that include data for use by nearby vehicles to determine the autonomous vehicle's position, orientation, and occupancy. For example, such messages with the message data structure 290 may include a first dataset 291 indicating the autonomous vehicle's origin point coordinates (e.g., [x1,y1,z1]), such as a vector or an array including global values (e.g., GPS coordinate values) for a position of the autonomous vehicle (e.g., x-axis, y-axis, z-axis). The first dataset 291 may be needed to provide the global position of the autonomous vehicle at a given time. In some embodiments, such origin point coordinates may be offset from original values as obtained from a GPS navigation system in order to accurately represent the center point of the autonomous vehicle. For example, the computing device may identify offset values by determining the difference between a predefined installation location of an antenna and the known center point as defined within manufacturer specifications.

The message data structure 290 may also include a second dataset 292 that may include a first subset 293a indicating the autonomous vehicle's termination point coordinates (e.g., [x2, y2, z2]), such as a vector or an array including global values (e.g., GPS coordinate values) for an end of the autonomous vehicle, and/or a second subset 293b indicating a unit vector (e.g., [a1, a2, a3]) calculated by the computing device of the autonomous vehicle using the termination point coordinates and the origin point coordinates. In some embodiments, the message data structure 290 may only include one of the subsets 293a, 293b. For example, when the message data structure 290 includes the first subset 293a, the unit vector data of the second subset 293b may not be included as recipient devices may be able to compute the unit vector using the origin point coordinates of the first dataset 291 and the termination point coordinates of the first subset 293a. As another example, when the message data structure 290 includes the unit vector in the second subset 293b, recipient devices may not need termination point coordinates as the unit vector is pre-calculated by the sending device.

The message data structure 290 may also include a third dataset 294 providing dimensions of the autonomous vehicle, such as data indicating the length of the autonomous vehicle (‘l’), width of the autonomous vehicle (‘w’), and height of the autonomous vehicle (‘h’). Such dimensions data may be based on predefined data stored on the computing device, such as autonomous vehicle specifications data provided by a manufacturer. In some embodiments, the vehicle dimensions data may include dimensions representing one-half measurements (e.g., one half of the total length, one half of the total height, one half of the total width). Such half values may be used with unit vectors for identifying boundaries from the center point of the autonomous vehicle defined by the origin point coordinates of the first dataset 291. For example, a recipient computing device may combine (e.g., multiply) the unit vector from the second subset 293b with a one-half width measurement in order to find the lateral boundary to one side of the autonomous vehicle.

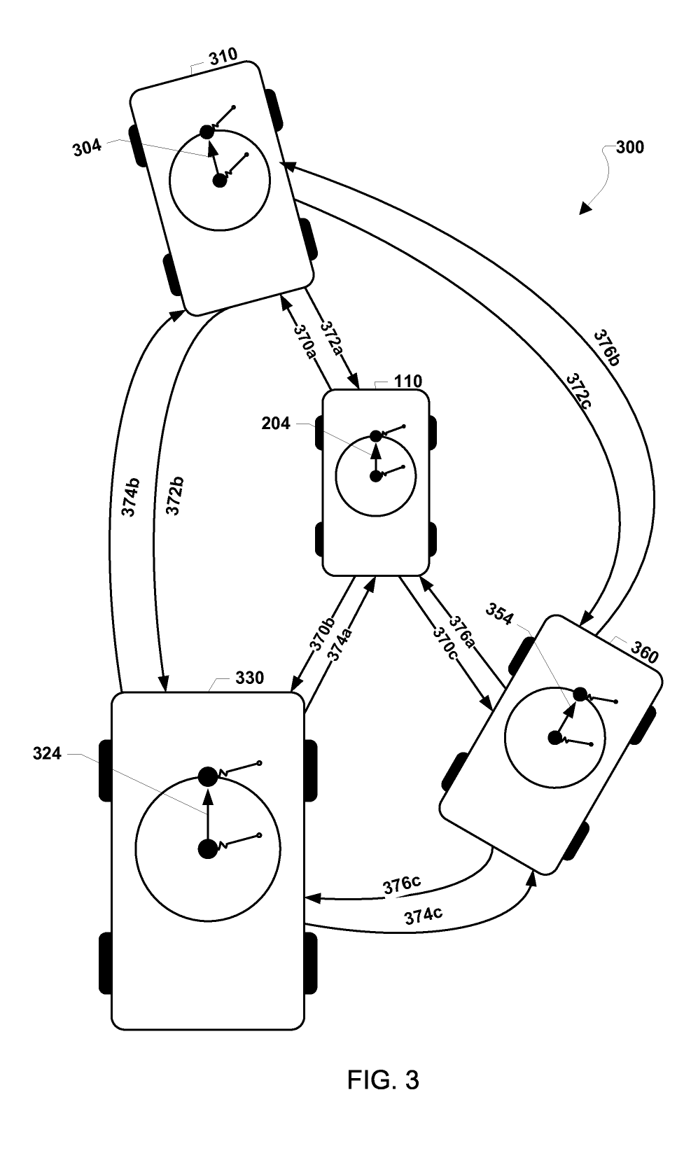

FIG. 3 illustrates a plurality of autonomous vehicles 110, 310, 330, 360 interacting in a communication system 300 according to various embodiments. The autonomous vehicles 110, 310, 330, 360 may be various types of autonomous vehicles, such as self-driving cars, trucks, bikes, etc., and may be traveling on a conventional roadway (e.g., a highway, a street, etc.). With reference to FIGS. 1-3, each autonomous vehicle 110, 310, 330, 360 may be configured with two satellite-based navigation functionalities (e.g., two GPS antenna, etc.) capable of receiving accurate global position information for generating unit vectors. For example, each of the autonomous vehicles 110, 310, 330, 360 may be configured to use components similar to those described (e.g., with reference to FIG. 2A) in order to identify origin point coordinates and termination point coordinates associated with each of the autonomous vehicles 110, 310, 330, 360 and used to calculate associated individual unit vectors. The plurality of autonomous vehicles 110, 310, 330, 360 may also be configured to utilize DSRC transceivers for exchanging communications 370a-370c, 372a-372c, 374a-374c, 376a-376c with one another when within transmission range.

As described, such communications 370a-370c, 372a-372c, 374a-374c, 376a-376c may provide data that may be used by each of the plurality of autonomous vehicles for determining orientation, position, and occupancy of one another (e.g., unit vectors, dimensions data, etc.). For example, the first autonomous vehicle 110 may share a first unit vector 204, global position data, and dimensions with nearby autonomous vehicles 310, 330, 360 via communications 370a, 370b, 370c, a second autonomous vehicle 310 may share a second unit vector 304, global position data, and dimensions with nearby autonomous vehicles 110, 330, 360 via communications 372a, 372b, 372c, a third autonomous vehicle 330 may share a third unit vector 324, global position data, and dimensions with nearby autonomous vehicles 110, 310, 360 via communications 374a, 374b, 374c, and a fourth autonomous vehicle 360 may share a fourth unit vector 354, global position data, and dimensions with nearby autonomous vehicles 110, 310, 330 via communications 376a, 376b, 376c. In some embodiments, the various communications 370a-370c, 372a-372c, 374a-374c, 376a-376c may include broadcasts and/or two-way transmissions between the autonomous vehicles 110, 310, 330, 360.

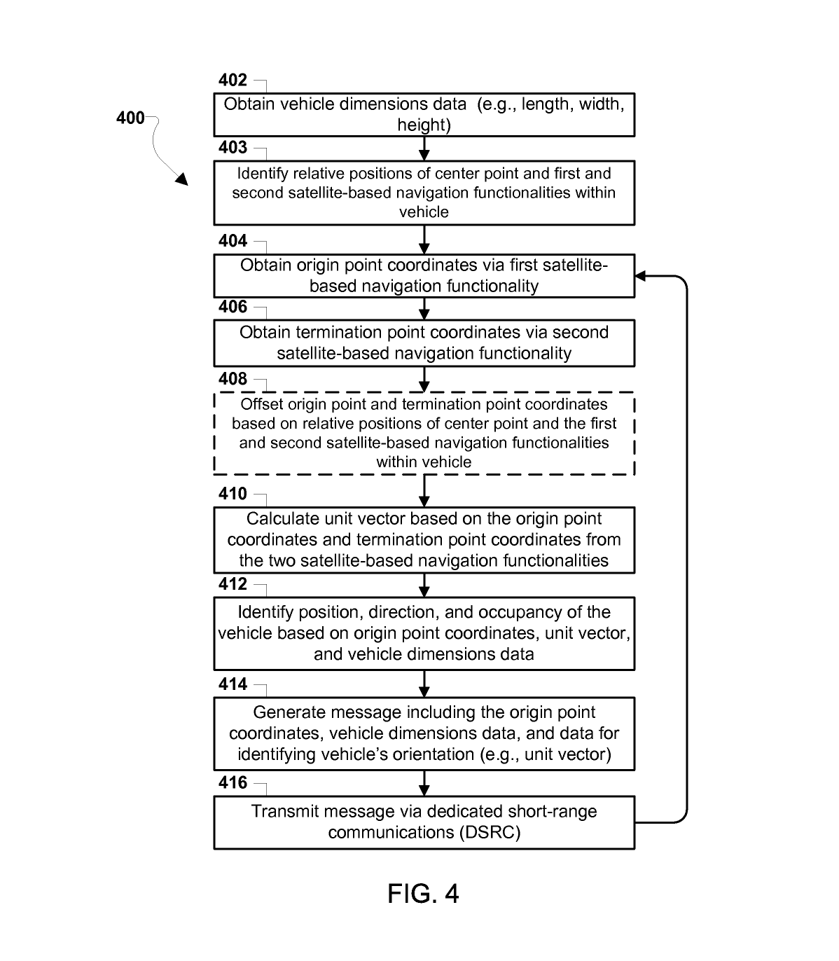

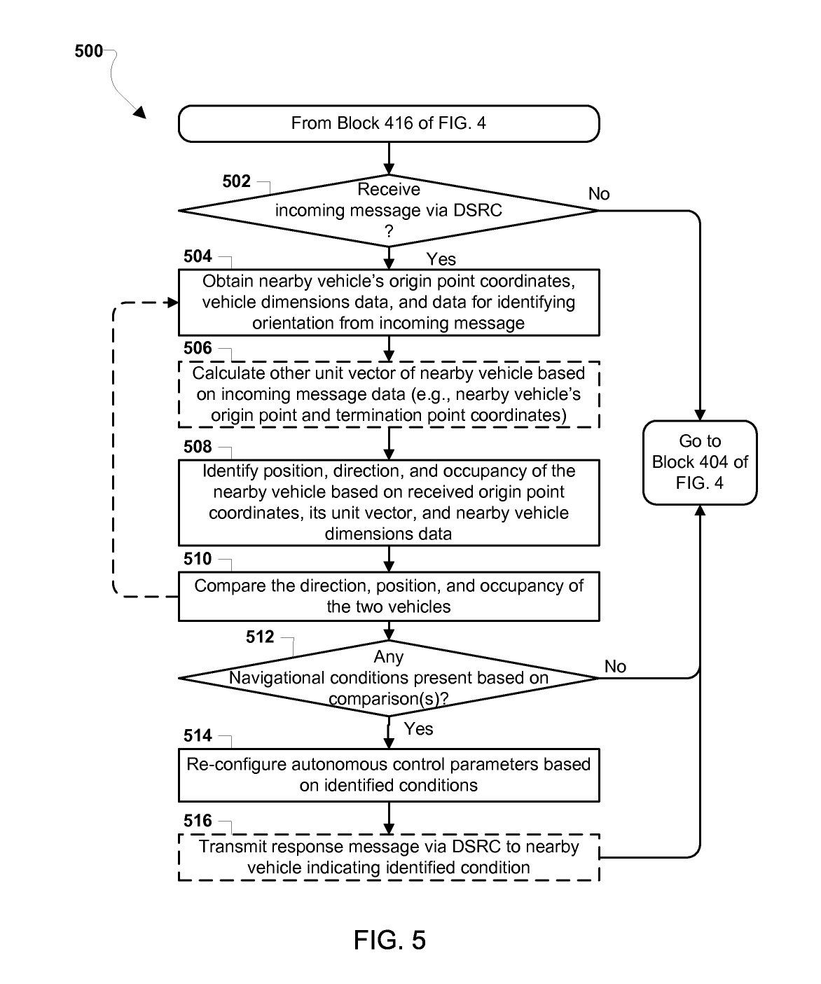

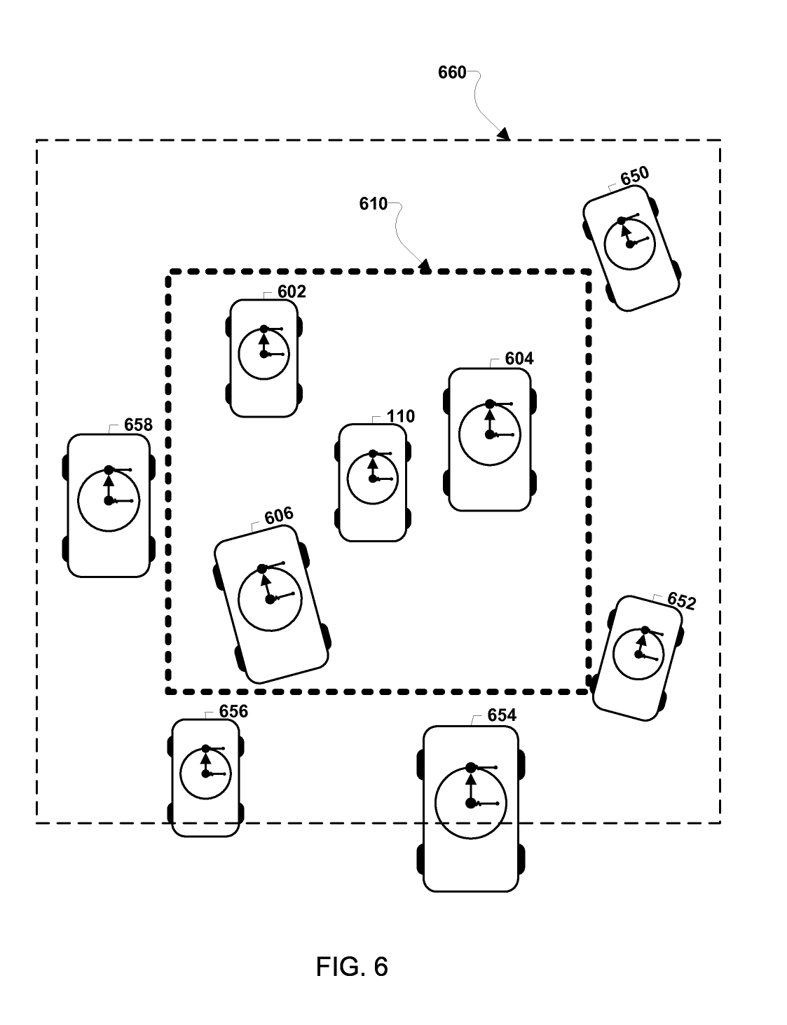

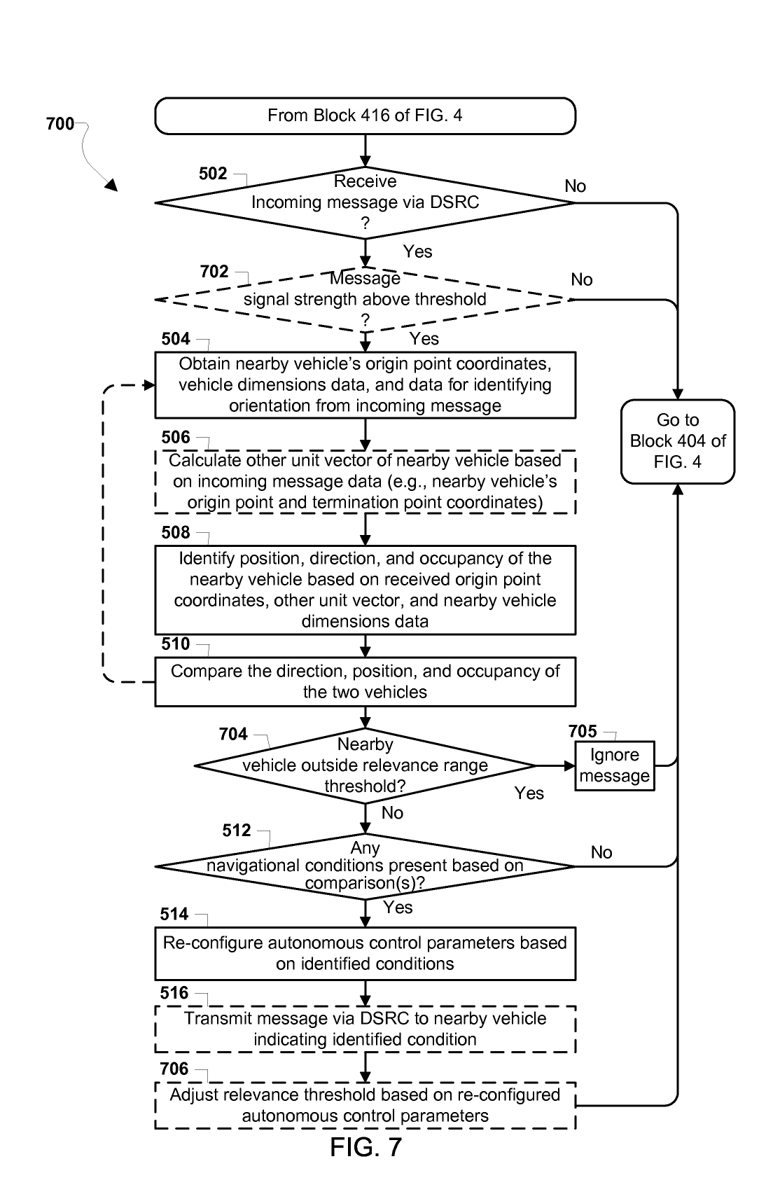

FIG. 4 illustrates a method 400 for a computing device within an autonomous vehicle to transmit dedicated short-range communications (DSRC) that indicate unit vectors based on two GPS coordinate sets according to various embodiments. For example, the computing device may perform the method 400 to calculate the autonomous vehicle's unit vector based on data from two separate GPS antennas for broadcast to nearby devices (e.g., other autonomous vehicles). In some embodiments, the computing device may be any number of devices within the autonomous vehicle capable of performing software routines, instructions, and/or other operations related to the control of the autonomous vehicle, such as one or more processing units associated with the various systems of the autonomous vehicle (e.g., navigation system, autonomous vehicle operating system, etc.). An exemplary computing device of an autonomous vehicle is described with reference to FIG. 10. In some embodiments, the autonomous vehicle computing device may be a computing device that is coupled to the autonomous vehicle, such as via wired or wireless connection(s), such as Bluetooth® connection and/or a Universal Serial Bus (USB) connection.

With reference to FIGS. 1-4, in block 402, a computing device of the autonomous vehicle may obtain vehicle dimensions data (e.g., length, width, height) of the autonomous vehicle. The vehicle dimensions data may be locally stored data provided by a manufacturer, a mechanic, a user, an owner, and/or other entity having specifications and/or measurements for the physical dimensions of the autonomous vehicle. For example, the computing device may retrieve length, width, and height dimensions data from a storage unit or memory populated during a manufacturing process, a firmware update, a vehicle check-up at a service station, etc.

In block 403, the computing device may identify relative positions of a center point, a first satellite-based navigation functionality, and a second satellite-based navigation functionality within the autonomous vehicle. The relative positions may be predefined three-dimensional points (e.g., x, y, z coordinates) or other measurements on the x-axis, y-axis, and z-axis that indicate the relative placement or location of the center point and the satellite-based navigation functionalities (e.g., GPS receivers/antenna). In other words, the relative positions may be points or coordinates that are relative to the general cubic space occupied by the autonomous vehicle. For example, the relative position of the center point may indicate the number of inches, centimeters, feet, etc. from the front (or back), side, and/or top (or bottom) of the autonomous vehicle. As another example, the relative position of a first satellite-based navigation functionality may be a number of feet from the back of the autonomous vehicle, etc. Exemplary relative positions are described (e.g., with reference to FIG. 2B). In some embodiments, the computing device may be configured to calculate the center point (or relative position of the center point) based on the vehicle dimensions data, such as by dividing each of the length, width, and height dimensions by two (e.g., a 3D vector [w/2, h/2, l/2]).

In block 404, the computing device may obtain origin point coordinates via the first satellite-based navigation functionality. For example, the computing device may query the first satellite-based navigation functionality to retrieve the latest GPS coordinates corresponding to a first GPS antenna. In general, the origin point coordinates may be considered a global position of the autonomous vehicle. In block 406, the computing device may obtain termination point coordinates via the second satellite-based navigation functionality. For example, the computing device may query the second satellite-based navigation functionality to retrieve the latest GPS coordinates corresponding to a second GPS antenna.

In optional block 408, the computing device may offset the origin point coordinates and the termination point coordinates based on the relative positions of the center point and/or the first and second satellite-based navigation functionalities (e.g., GPS functionalities) within the autonomous vehicle. For example, when the relative position of the center point as identified with the operations of block 403 is not the same as the relative position of the first satellite-based navigation functionality within the autonomous vehicle, the computing device may calculate this difference between the relative positions and adjust both the origin point coordinates and the termination point coordinates by the difference. Such offsetting may simplify other calculations that the computing device or computing devices within the vehicle may be required to make in order to identify the space occupied by the autonomous vehicle. In some embodiments, offsetting may not be required when the relative position of the first satellite-based navigation functionality is the same as the relative position of the center point.

In some embodiments, when the relative position of the second satellite-based navigation functionality is not in alignment with the first satellite-based navigation functionality (e.g., both having the same x-axis and y-axis position), the computing device may offset the termination point coordinates by such a relative difference. For example, when the second GPS antenna is located on the right side of the autonomous vehicle and the first GPS antenna is located in the middle of the autonomous vehicle, the computing device may identify angle(s) on various axes that may be applied to the relative position of the second GPS antenna to rotate the relative position of the second GPS antenna around the relative position of the first GPS antenna in order to offset the relative position of the second GPS antenna into alignment with the relative position of the first GPS lengthwise down the autonomous vehicle. The computing device may apply rotational transform(s) based on these identified angles to the termination point coordinates around the origin point coordinates in order to make an offset.

The following is a non-limiting illustration of the operations of blocks 402-408. The computing device may retrieve vehicle dimensions data from a local storage unit (or other storage unit) that indicates the autonomous vehicle is 10 feet long (i.e., l=10), 6 feet wide (i.e., w=6), and 6 feet tall (i.e., h=6). The computing device may calculate the relative position of the center point of the autonomous vehicle to be the vector [3, 3, 5] (i.e., the middle of the width (w/2), the middle of the height (h/2), and the middle of the length (l/2)). Based on other data stored within the local storage unit, the computing device may identify that the vector indicating the relative position of a first GPS antenna is [3, 6, 5] (i.e., 3 feet from the side of the autonomous vehicle (i.e., x=3), 6 feet from the bottom of the autonomous vehicle (i.e., y=6), and 5 feet from the back of the autonomous vehicle (i.e., z=5)). The computing device may identify that the vector indicating the relative position of a second GPS antenna is [3, 6, 10] (i.e., 3 feet from the side of the autonomous vehicle (i.e., x=3), 6 feet from the bottom of the autonomous vehicle (i.e., y=6), and 10 feet from the back of the autonomous vehicle (i.e., z=10)). Using the relative position of the first GPS antenna and the relative position of the center point of the autonomous vehicle, the computing device may identify an offset vector as [0, −3, 0] (i.e., the difference between [3, 3, 5] and [3, 6, 5]). At a certain time, the computing device may query the satellite-based navigation functionality associated with the first antenna to obtain global (i.e., not relative) origin point coordinates as [120, 120, 120], and also may query the satellite-based navigation functionality associated with the second antenna to obtain global (i.e., not relative) termination point coordinates as [120, 120, 130]. Using the identified offset vector (i.e., [0, −3, 0]), the computing device may offset the original point coordinates to be [120, 117, 120] and the termination point coordinates to be [120, 117, 130].

In block 410, the computing device may calculate a unit vector based on the origin point coordinates and termination point coordinates from the two satellite-based navigation functionalities (e.g., GPS functionalities). For example, the computing device may utilize various operations and equations (e.g., as described with reference to FIGS. 2C-2D) to calculate the unit vector, such as by utilizing “Equation 1”. In some embodiments, the unit vector may be relative to the autonomous vehicle such that the unit vector indicates the orientation of the autonomous vehicle without indicating the global coordinates of the origin point coordinates.

In block 412, the computing device may identify a position (i.e., a global position), a direction, and an occupied space (or occupancy) of the autonomous vehicle based on the origin point coordinates, the calculated unit vector, and the vehicle dimensions data. The position may be the global coordinates indicated by the origin point coordinates, the unit vector may indicate the orientation or direction the autonomous vehicle is pointed, and the vehicle dimensions data may indicate how much space the autonomous vehicle is occupying.

In some embodiments, the computing device may identify the space the autonomous vehicle is currently occupying (or the occupancy of the autonomous vehicle) by using length, width, and height dimensions data to identify a 3D bounding box (e.g., as described with reference to FIG. 2B). The computing device may apply a mathematical transform corresponding to the unit vector to the bounding box to orient the bounding box. For example, the computing device may apply a rotation to the bounding box in order to represent how the autonomous vehicle is pointed in a particular coordinate system, such as a global coordinate system. The computing device may apply a second transform (e.g., a translation) corresponding to the origin point coordinates in order to place the oriented bounding box in a global position that can be compared to occupied space of other vehicles.

The following is an illustration of using the unit vector to identify a 3D bounding box of the autonomous vehicle. The computing device may apply a first transform to orient the unit vector to reorient the unit vector along the z-axis (i.e., zero-out any rotation). The computing device may scale the re-oriented unit vector by half the length of the autonomous vehicle (i.e., l/2) to identify the front of a bounding box relative to the center point of the vehicle, and may negatively scale the re-oriented unit vector by half the length (i.e., −l/2) to identify the front of the bounding box relative to the center point of the vehicle. Alternatively, the computing device may utilize another value to scale the unit vector depending on the relative mounting of a satellite-based navigation functionality (e.g., a GPS antenna/receiver) with respect to the autonomous vehicle's origin of symmetry.

In order to identify the sides of the bounding box, the computing device may apply a second transform to the unit vector to rotate the vector onto the y-axis so that the vector is at a right angle to the z-axis (i.e., oriented to the side on the y-axis). The computing device may scale the transformed unit vector by half the width (i.e., w/2) to identify one side of the bounding box, and may negatively scale the transformed unit vector by half the width (i.e., −w/2) to identify the other side of the bounding box.

In order to identify the top and bottom of the bounding box, the computing device may apply a third transform to the unit vector to rotate the unit vector on the x-axis so that the unit vector is at a right angle to the z-axis (i.e., oriented upwards on the x-axis). The computing device may the scale the transformed unit vector by half the height (i.e., h/2) to identify the top of the bounding box, and may negatively scale the transformed unit vector by half the height (i.e., −h/2) to identify the bottom of the bounding box.

The computing device may calculate the global position of autonomous vehicle's bounding box by transforming (i.e., translating) the coordinates of the relative positions (e.g., top, bottom, left, right, front, back, etc.) of the bounding box using the origin point coordinates.

In block 414, the computing device may generate a message including the origin point coordinates, the vehicle dimensions data, and data for identifying the autonomous vehicle's orientation (e.g., the unit vector). In other words, the generated message may include a small amount of data that may indicate the autonomous vehicle's global position (i.e., the origin point coordinates), the autonomous vehicle's orientation (i.e., the unit vector), and data that may be used to identify the space occupied by the autonomous vehicle (e.g., vehicle dimensions that may be combined with the unit vector and the origin point coordinates). In some embodiments, the generated message may include the termination point coordinates in addition to or in place of the unit vector, enabling recipient devices to calculate the unit vector independently.

In block 416, the computing device may transmit the generated message to other vehicles via dedicated short-range communications (DSRC). For example, the computing device may cause one or more wireless communications to be broadcast for reception by transceivers of nearby autonomous vehicles within broadcast range of the autonomous vehicle. The computing device may repeat the operations of the method 400 by obtaining subsequent coordinates via the satellite-based navigation functionalities (e.g., GPS receivers/antenna) in block 404.

FIG. 5 illustrates an embodiment method 500 for a computing device within an autonomous vehicle to receive and process dedicated short-range communications (DSRC) from nearby autonomous vehicles that indicate unit vectors based on two GPS coordinate sets according to some embodiments. The method 500 may be performed by the computing device concurrently or in combination with execution of the method 400 (FIG. 4) as described. For example, the computing device may be configured to perform both broadcasting operations to provide data informing nearby autonomous vehicles of the autonomous vehicle's position, orientation, and occupancy and receiving operations to use data from the nearby autonomous vehicles to identify the nearby autonomous vehicles' positions, orientations, and occupancies.

With reference to FIGS. 1-5, the method 500 may include the operations of blocks 402-416 as described for like numbered blocks with reference to FIG. 4. In other words, the computing device of an autonomous vehicle may begin the method 500 by performing the operations of blocks 402-416 as described with reference to FIG. 4. The computing device may determine whether an incoming message is received via DSRC in determination block 502. For example, the computing device may monitor an incoming message buffer associated with a DSRC functionality (e.g., antenna, module, etc.) to identify newly received broadcast messages from nearby autonomous vehicles. In response to determining that no incoming message has been received via DSRC (i.e., determination block 502=“No”), the computing device may continue performing the operations of blocks 402-416.

In response to determining that an incoming message has been received via DSRC (i.e., determination block 502=“Yes”), the computing device may obtain a nearby autonomous vehicle's origin point coordinates, nearby autonomous vehicle dimensions data, and data for identifying orientation of the nearby autonomous vehicle dimensions data from the incoming message in block 504. For example, the computing device may parse the incoming message to obtain the origin point coordinates of the nearby autonomous vehicle that sent the received message (i.e., nearby autonomous vehicle origin point coordinates), a unit vector indicating the nearby autonomous vehicle's orientation (i.e., data for identifying an orientation of the nearby autonomous vehicle), and data indicating the nearby autonomous vehicle's length measurement, width measurement, and height measurement (i.e., nearby vehicle dimensions data).

In optional block 506, the computing device may calculate a unit vector of the nearby autonomous vehicle based on the nearby autonomous vehicle's origin point coordinates and termination point coordinates. For example, when the incoming message includes the origin point coordinates and termination point coordinates of the nearby autonomous vehicle does not a unit vector, the computing device may use both sets of coordinates to calculate the nearby autonomous vehicle's unit vector, such as by using operations similar to those described (e.g., with reference to block 410 of FIG. 4 and as illustrated in FIGS. 2C-2D).

In block 508, the computing device may identify the direction, position, and occupancy of the nearby autonomous vehicle based on the received origin point coordinates, the nearby autonomous vehicle's unit vector, and the vehicle dimensions data associated with the nearby autonomous vehicle. The operations in block 508 may be similar to those described with reference to block 412. For example, the nearby autonomous vehicle's global position may be identified as the location indicated by the nearby autonomous vehicle's origin point coordinates, the orientation of the nearby autonomous vehicle may be indicated by a corresponding unit vector (e.g., unit vector calculated by the computing device or received within the incoming message), and the space occupied by the nearby autonomous vehicle may be represented based on applying the length, width, and height of the nearby autonomous vehicle to the nearby autonomous vehicle's unit vector and origin point coordinates. In some embodiments, the computing device may generate a bounding box for the nearby autonomous vehicle based on the nearby autonomous vehicle's unit vector, origin point coordinates, and vehicle dimensions data, such as described.

In block 510, the computing device may compare the direction, position, and occupancy of the autonomous vehicle and the nearby autonomous vehicle associated with the received incoming message. For example, the computing device may compare the bounding boxes of the two autonomous vehicles to determine how close the autonomous vehicles are (or may be in the near future). In some embodiments, the computing device may continue with the operations in block 504 to obtain data from other incoming messages that were received concurrently or received within a certain time period of the already evaluated incoming message. In this manner, the computing device may compare the autonomous vehicle's position, orientation, and space occupied to a plurality of nearby autonomous vehicles.

In determination block 512, the computing device may determine whether there are any navigational conditions that may require changes to the autonomous vehicle's operation based on the comparison(s) performed in block 510. In particular, the computing device may determine whether there is a risk of a collision between the autonomous vehicle and any of the nearby autonomous vehicles associated with the incoming messages. For example, when the comparison indicates that the distance between the autonomous vehicle and nearby autonomous vehicle is less than a predefined separation distance threshold or that the vehicles are approaching each other such that the separation distance will soon be less than the predefined separation distance threshold, the computing device may determine that a collision is or may be likely, and thus the autonomous vehicle orientation and/or speed should be changed and/or that brakes should be applied. As another example, the computing device may evaluate the vector or coordinate data received from other nearby vehicles to determine the degree of congestion on the roadway, which may be used in selecting a speed for the autonomous vehicle. As another example, the computing device may determine from the vector or coordinate data received from other nearby vehicles that several nearby autonomous vehicles are in an adjacent lane of a highway, and thus determine that moving the autonomous vehicle into that lane would be too risky to perform due to the congestion. Based on the comparison(s), the computing device may also determine whether there are openings or other opportunities for changing the course of the autonomous vehicle. For example, when there is clearance from nearby autonomous vehicles adjacent to the autonomous vehicle, the computing device may determine that the autonomous vehicle may change lanes or make a turn.

In response to determining that there are no navigational conditions present that require changes to the autonomous vehicle's operation (i.e., determination block 512=“No”), the computing device may repeat the method 500 by again determining the vehicle's location coordinates in block 404 and processing the information as described.

In response to determining that there are navigational conditions present that require changes to the autonomous vehicle's operation (i.e., determination block 512=“Yes”), the computing device may re-configure one or more autonomous control parameters based on the identified conditions in block 514. Re-configuring the autonomous control parameters may include adjusting one or more of a traversal path, a speed, and an application of brakes of the autonomous vehicle. For example, the computing device may adjust a timing parameter for making a turn or merge into a lane based on the closeness of nearby autonomous vehicles. As another example, the computing device may adjust a speed setting to cause the autonomous vehicle to slow down (or speed up) in order to avoid a collision with another autonomous vehicle. As another example, the computing device may adjust a setting that controls the amount of braking for a period in order to cause faster or slower braking based on the autonomous vehicle's closeness to nearby autonomous vehicles.

In optional block 516, the computing device may transmit a response message via DSRC to nearby autonomous vehicles indicating the identified conditions. For example, the computing device may cause a response message to be broadcast that indicates the autonomous vehicle was within a dangerous proximity of nearby autonomous vehicles. In some embodiments, the message may indicate operations the computing device has performed or may perform in the near future based on the identified conditions. For example, the message may indicate that the autonomous vehicle will make a turn, merge into a lane, and/or apply speed or brakes in response to identifying an opportunity to maneuver within a roadway. The computing device may repeat the method 500 by again determining the vehicle's location coordinates in block 404 and processing the information as described.

FIG. 6 illustrates a first plurality of autonomous vehicles 602-606 and a second plurality of autonomous vehicles 650-658 within a DSRC transmission range 660 from the first autonomous vehicle 110. With reference to FIGS. 1-6, dedicated short-range communications from any of the autonomous vehicles 602-606, 650-658 may be received by the first autonomous vehicle 110, and vice versa. As described, data within such dedicated short-range communications (e.g., GPS coordinate sets, dimensions data, etc.) from nearby autonomous vehicles may be used by the first autonomous vehicle 110 to identify position, orientation, and spatial occupancy of the nearby autonomous vehicles. For example, dedicated short-range communication received from any of the first plurality of autonomous vehicles 602-606, 650-658 may be used by the first autonomous vehicle 110 to calculate each autonomous vehicle's unit vector and occupancy for determining how the first autonomous vehicle 110 may maneuver on a road without colliding with the nearby autonomous vehicles.

However, due to the potentially wide coverage of the DSRC transmission range 660 (e.g., 1000 meters, a mile, etc.), the first autonomous vehicle 110 may receive dedicated short-range communications from some autonomous vehicles that may not be directly relevant to the movement, safety, and/or other spatial considerations of the first autonomous vehicle 110. For example, transmissions may be received at the first autonomous vehicle 110 from a second autonomous vehicle 654 even though the distance between the two devices is such that the two autonomous vehicles 110, 654 are unlikely to pose a risk of collision to each other for one or more time-steps (e.g., a few seconds, a minute, etc.). In other words, dedicated short-range communications from any of the second plurality of autonomous vehicles 650-658 may not be needed by the first autonomous vehicle 110 at a given time when the two vehicles are sufficiently far apart. Accordingly, the first autonomous vehicle 110 may be configured to filter received dedicated short-range communications to ignore transmissions from autonomous vehicles that are not within a predetermined relevance range 610. Such a relevance range 610 may be configured to be large enough to encompass the first plurality of autonomous vehicles 602-606 but not the second plurality of autonomous vehicles 650-658. In some embodiments, the relevance range 610 may correspond to signal strengths of dedicated short-range communications.

In some embodiments, the relevance range 610 may change based on various factors associated with the first autonomous vehicle 110 or other vehicles 602-606, 650-658. For example, the relevance range 610 may change based on a current brake pad condition (or level of wear) such that the relevance range 610 represents the current ability of the first autonomous vehicle 110 to brake (e.g., relevance range 610 may be larger with a decreased braking ability, etc.). In some embodiments, the relevance range 610 may take into account the autonomous vehicle's motion, such as by extending farther ahead than behind the first autonomous vehicle 110. In some embodiments, the relevance range 610 may take into account the motions of multiple vehicles, such as indicated in DSRC messages or other motion/speed determinations. In some embodiments, the relevance range 610 may change based on a current speed of the first autonomous vehicle 110. For example, if the first autonomous vehicle 110 is traveling at a fast speed, the first autonomous vehicle 110 may identify more cars that may be relevant than when the first autonomous vehicle 110 is traveling at a slower speed (i.e., the relevance range 610 may be larger at higher speeds). The relevance range 610 may also be changed based on the detection of various weather conditions (e.g., rain, snow, etc.). For example, the relevance range 610 may be changed by the first autonomous vehicle 110 based on whether windshield wipers are on/off, data from a weather sensor, and/or data obtained from a weather service via a wireless data link.

FIG. 7 illustrates a method 700 for a computing device within an autonomous vehicle to process dedicated short-range communications (DSRC) that indicate unit vectors based on two GPS coordinate sets and that are received within a relevance range threshold from nearby autonomous vehicles according to some embodiments. For example, although messages may be received from a plurality of autonomous vehicles within a DSRC broadcast range, the computing device of the autonomous vehicle may ignore any messages from autonomous vehicles outside a distance from the autonomous vehicle that the computing device determines to be relevant for affecting near maneuvers (e.g., turns, merging, braking, etc.) by the autonomous vehicle. With reference to FIGS. 1-7, the method 700 may include the operations of blocks 402-416 and the operations of blocks 502-510, 512-516.

In response to determining that an incoming message is received via DSRC (i.e., determination block 502=“Yes”), the computing device may determine whether the incoming message has a signal strength that exceeds a predefined threshold in optional determination block 702. For example, the computing device may assess the signal strength of the incoming message and compare that signal strength to a predefined minimum signal strength value stored in memory (e.g., within a register, etc.). In response to determining that the signal strength of the incoming message does not exceed the threshold (i.e., optional determination block 702=“No”), the computing device may repeat the method 700 by obtaining updated location coordinates in block 404. In response to determining that the signal strength of the incoming message exceeds the threshold (i.e., optional determination block 702=“Yes”), the computing device may perform the operations of blocks 504-510.

In determination block 704, the computing device may determine whether the nearby autonomous vehicle associated with the received incoming message is outside of a predefined relevance range threshold. In particular, the computing device may compare the global position data from the received message (i.e., origin point coordinates of the nearby autonomous vehicle) to the origin point coordinates of the autonomous vehicle and calculate a difference (or radius). If the difference exceeds a predefined relevance range, the computing device may determine that the nearby autonomous vehicle is too far to be considered relevant, and thus may ignore the incoming message without adjusting the autonomous control parameters. However, if the nearby autonomous vehicle's global position is within the predefined relevance threshold or distance, the computing device may perform operations to determine whether a condition exists related to the nearby autonomous vehicle that may require an adjustment in the autonomous control parameters.

In response to determining that the nearby autonomous vehicle associated with the received incoming message is outside of the predefined relevance threshold (i.e., determination block 704=“Yes”), the computing device may ignore the received message in block 705, and the computing device may repeat the method 700 by obtaining updated location coordinates in block 404.

In response to determining that the nearby autonomous vehicle associated with the received incoming message is within the predefined relevance threshold (i.e., determination block 704=“No”), the computing device may perform the operations of blocks 512-516. In optional block 706, the computing device may adjust the relevance threshold based on the re-configured autonomous control parameters. For example, when the autonomous vehicle is configured to operate at a higher or lower speed based on the identified conditions, the computing device may increase or decrease the radius of the relevance range to compensate. The computing device may repeat the method 700 by obtaining updated location coordinates in block 404.

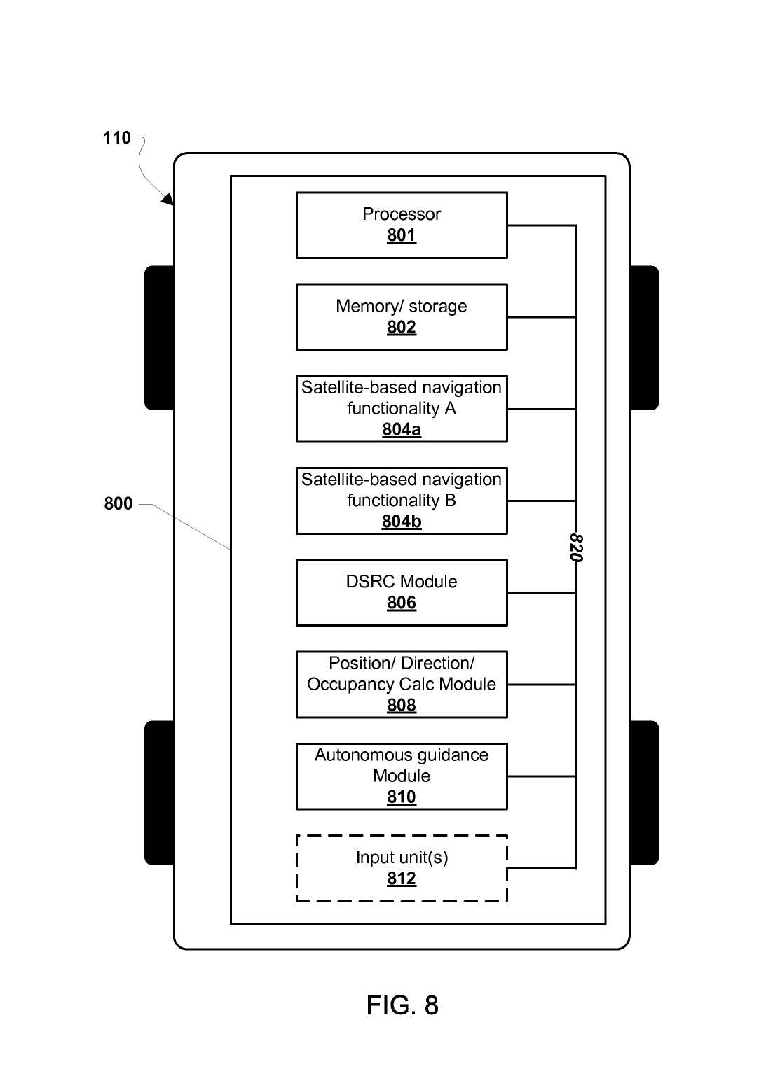

Autonomous vehicles may include various computing devices to manage various functionalities, including the position, orientation, and occupancy determination functionalities as described herein with reference to the various embodiments. FIG. 8 illustrates an exemplary computing device 800 (or computing system) within an exemplary autonomous vehicle 110 (e.g., a self-driving car, etc.) suitable for use with the various embodiments. With reference to FIGS. 1-8, the computing device 800 may include a processor 801 coupled to internal memory 802 that may be volatile or non-volatile memory, and may be secure and/or encrypted memory, or unsecure and/or unencrypted memory, or any combination thereof. The processor 801 may also be coupled to a first satellite-based navigation functionality 804a (e.g., a first GPS module/receiver/antenna) and a second satellite-based navigation functionality 804b (e.g., a second GPS module/receiver/antenna). Each of the satellite-based navigation functionalities 804a, 804b may be configured to receive signals from satellites (e.g., navigation satellites associates with GPS, Galileo, etc.) in orbit overhead that the satellite-based navigation functionalities 804a, 804b may use to calculate accurate global coordinates. In some embodiments, the satellite-based navigation functionalities 804a, 804b may include one or more antenna for wirelessly receiving location information, such as an antenna array. Further, the satellite-based navigation functionalities 804a, 804b may include various processing units, logic, circuitry, routines, and/or other functionalities required for processing satellite signals and calculating highly accurate global position coordinates.

The computing device 800 may further include a DSRC module 806 configured to receive, transmit, and otherwise handle wireless communications exchanged between the autonomous vehicle 110 and other nearby autonomous vehicles within transmission range. For example, the DSRC module 806 may include an antenna for receiving or transmitting messages for communicating with an ad hoc network of nearby autonomous vehicles similarly equipped with DSRC modules. The computing device 800 may further include a position/direction/occupancy calculation module 808 configured to utilize global position data (e.g., GPS coordinates) from the satellite-based navigation functionalities 804a, 804b and/or received from the DSRC module 806. For example, the position/direction/occupancy calculation module 808 may be configured to take termination point coordinates, origin point coordinates, and vehicle dimensions data received from a nearby autonomous vehicle via dedicated short-range communications (DSRC) and calculate the space occupied by the nearby autonomous vehicle, as well as the nearby autonomous vehicle's global position and orientation, as described.

The computing device 800 may further include an autonomous guidance module 810 configured to receive and process various data, including sensor data and nearby autonomous vehicle positions/orientations/occupancy, in order to determine subsequent operations for the computing device 800 to perform in order to control the route and operation of the autonomous vehicle 110. For example, based on a predicted collision between the autonomous vehicle 110 and another autonomous vehicle due to incoming dedicated short-range communications (DSRC) and determined unit vectors, global positions, and occupancies, the autonomous guidance module 810 may generate instructions to be delivered to a braking system to cause the autonomous vehicle 110 to stop forward progression in order to avoid the predicted collision. In some embodiments, the computing device 800 may also include various input unit(s) 812, such as various sensors (e.g., cameras, microphones, radars, accelerometers, gyroscopes, magnetometers, etc.). Such input unit(s) 812 may be used to provide data that may supplement navigational systems, such as data that may be used by the processor 801 to performing immediate or emergency navigational operations during periods when no navigation satellite information can be received (e.g., when within a tunnel, etc.). Each of the components 801-812 may be coupled together via an internal bus 820.

The various processors described herein may be any programmable microprocessor, microcomputer or multiple processor chip or chips that can be configured by software instructions (applications) to perform a variety of functions, including the functions of the various embodiments described herein. In the various devices, multiple processors may be provided, such as one processor dedicated to wireless communication functions and one processor dedicated to running other applications. Typically, software applications may be stored in internal memory before being accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described generally in terms of associated functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory processor-readable, computer-readable, or server-readable medium or a non-transitory processor-readable storage medium. The operations of a method or algorithm disclosed herein may be embodied in a processor-executable software module or processor-executable software instructions which may reside on a non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for a computing device of an autonomous vehicle to generate real-time mappings of nearby autonomous vehicles using dedicated short-range communications (DSRC), comprising:
obtaining, by the computing device, origin point coordinates via a first satellite-based navigation functionality;
obtaining, by the computing device, termination point coordinates via a second satellite-based navigation functionality;
calculating, by the computing device, a unit vector based on the obtained origin point coordinates and the obtained termination point coordinates;
identifying, by the computing device, a first position, a first direction, and a first occupancy of the autonomous vehicle based on the obtained origin point coordinates, the calculated unit vector, and stored vehicle dimensions data, wherein the stored vehicle dimensions data include a length measurement and a width measurement of the autonomous vehicle; and
transmitting, by the computing device, a message using the DSRC that includes the obtained origin point coordinates, the stored vehicle dimensions data, and data for identifying the first direction of the autonomous vehicle.

2. The method of claim 1, further comprising:
identifying, by the computing device, relative positions of a center point of the autonomous vehicle, the first satellite-based navigation functionality, and the second satellite-based navigation functionality; and
offsetting, by the computing device, the obtained origin point coordinates and the obtained termination point coordinates based on the identified relative positions of the center point of the autonomous vehicle, the first satellite-based navigation functionality, and the second satellite-based navigation functionality,
wherein identifying, by the computing device, the first position and the first occupancy of the autonomous vehicle is based on the offset obtained origin point coordinates.

3. The method of claim 1, further comprising:
receiving, by the computing device, an incoming message from a nearby autonomous vehicle via the DSRC;
obtaining, by the computing device, nearby autonomous vehicle origin point coordinates, nearby autonomous vehicle dimensions data, and data for identifying an orientation of the nearby autonomous vehicle from the received incoming message;
identifying, by the computing device, a second position, a second direction, and a second occupancy of the nearby autonomous vehicle based on the obtained data from the received incoming message;
determining, by the computing device, whether any navigational conditions exist based on a comparison of the first position, the first direction, and the first occupancy of the autonomous vehicle and the second position, the second direction, and the second occupancy of the nearby autonomous vehicle; and
re-configuring, by the computing device, an autonomous control parameter in response to determining that a navigational condition exists.

4. The method of claim 3, further comprising transmitting, by the computing device using the DSRC, a response message indicating the identified navigational condition.

5. The method of claim 3, wherein the navigational condition is a risk of a collision between the autonomous vehicle and the nearby autonomous vehicle.

6. The method of claim 3, wherein re-configuring, by the computing device, the autonomous control parameter in response to determining that the navigational condition exists comprises adjusting, by the computing device, one or more of a traversal path, a speed, and an application of brakes of the autonomous vehicle.

7. The method of claim 3, further comprising determining, by the computing device, whether a signal strength of the incoming message exceeds a predefined threshold,
wherein obtaining, by the computing device, the nearby autonomous vehicle origin point coordinates, the nearby autonomous vehicle dimensions data, and the data for identifying the orientation of the nearby autonomous vehicle from the received incoming message comprises obtaining, by the computing device, the nearby autonomous vehicle origin point coordinates, the nearby autonomous vehicle dimensions data, and the data for identifying the orientation of the nearby autonomous vehicle from the received incoming message in response to determining that the signal strength of the incoming message exceeds the predefined threshold.

8. The method of claim 3, further comprising determining, by the computing device, whether the nearby autonomous vehicle is outside a relevance range threshold based on the comparison,
wherein determining, by the computing device, whether any navigational conditions exist based on the comparison of the first position, the first direction, and the first occupancy of the autonomous vehicle and the second position, the second direction, and the second occupancy of the nearby autonomous vehicle comprises determining, by the computing device, whether any navigational conditions exist based on the comparison of the first position, the first direction, and the first occupancy of the autonomous vehicle and the second position, the second direction, and the second occupancy of the nearby autonomous vehicle in response to determining that the nearby autonomous vehicle is within the relevance range threshold.

9. The method of claim 8, further comprising adjusting, by the computing device, the relevance range threshold based on the re-configured autonomous control parameter.

10. The method of claim 1, wherein the data for identifying the first direction of the autonomous vehicle includes the unit vector or the obtained termination point coordinates.

11. The method of claim 1, wherein the stored vehicle dimensions data includes a height measurement of the autonomous vehicle.

12. A computing device, comprising a processor configured with processor-executable instructions to:
obtain origin point coordinates via a first satellite-based navigation functionality;
obtain termination point coordinates via a second satellite-based navigation functionality;
calculate a unit vector based on the obtained origin point coordinates and the obtained termination point coordinates;
identify a first position, a first direction, and a first occupancy of an autonomous vehicle based on the obtained origin point coordinates, the calculated unit vector, and stored vehicle dimensions data, wherein the stored vehicle dimensions data include a length measurement and a width measurement of the autonomous vehicle, wherein the computing device is associated with the autonomous vehicle; and
transmit a message using dedicated short-range communications (DSRC) that includes the obtained origin point coordinates, the stored vehicle dimensions data, and data for identifying the first direction of the autonomous vehicle.

13. The computing device of claim 12, wherein the processor is further configured with processor-executable instructions to:
identify relative positions of a center point of the autonomous vehicle, the first satellite-based navigation functionality, and the second satellite-based navigation functionality;
offset the obtained origin point coordinates and the obtained termination point coordinates based on the identified relative positions of the center point of the autonomous vehicle, the first satellite-based navigation functionality, and the second satellite-based navigation functionality; and
identify the first position and the first occupancy of the autonomous vehicle based on the offset obtained origin point coordinates.

14. The computing device of claim 12, wherein the processor is further configured with processor-executable instructions to:
receive an incoming message from a nearby autonomous vehicle via the DSRC;
obtain nearby autonomous vehicle origin point coordinates, nearby autonomous vehicle dimensions data, and data for identifying an orientation of the nearby autonomous vehicle from the received incoming message;
identify a second position, a second direction, and a second occupancy of the nearby autonomous vehicle based on the obtained data from the received incoming message;
determine whether any navigational conditions exist based on a comparison of the first position, the first direction, and the first occupancy of the autonomous vehicle and the second position, the second direction, and the second occupancy of the nearby autonomous vehicle; and
re-configure an autonomous control parameter in response to determining that a navigational condition exists.

15. The computing device of claim 14, wherein the processor is further configured with processor-executable instructions to transmit a response message indicating the identified navigational condition.

16. The computing device of claim 14, wherein the navigational condition is a risk of a collision between the autonomous vehicle and the nearby autonomous vehicle.

17. The computing device of claim 14, wherein the processor is further configured with processor-executable instructions to re-configure the autonomous control parameter in response to determining that the navigational condition exists by adjusting one or more of a traversal path, a speed, and an application of brakes of the autonomous vehicle.

18. The computing device of claim 14, wherein the processor is further configured with processor-executable instructions to:
determine whether a signal strength of the incoming message exceeds a predefined threshold; and
obtain the nearby autonomous vehicle origin point coordinates, the nearby autonomous vehicle dimensions data, and the data for identifying the orientation of the nearby autonomous vehicle from the received incoming message in response to determining that the signal strength of the incoming message exceeds the predefined threshold.

19. The computing device of claim 14, wherein the processor is further configured with processor-executable instructions to determine whether the nearby autonomous vehicle is outside a relevance range threshold based on the comparison,
wherein the processor is further configured with processor-executable instructions to determine whether any navigational conditions exist based on the comparison of the first position, the first direction, and the first occupancy of the autonomous vehicle and the second position, the second direction, and the second occupancy of the nearby autonomous vehicle in response to determining that the nearby autonomous vehicle is within the relevance range threshold.

20. The computing device of claim 19, wherein the processor is further configured with processor-executable instructions to adjust the relevance range threshold based on the re-configured autonomous control parameter.

21. The computing device of claim 12, wherein the data for identifying the first direction of the autonomous vehicle includes the unit vector or the obtained termination point coordinates.

22. The computing device of claim 12, wherein the stored vehicle dimensions data includes a height measurement of the autonomous vehicle.

23. A non-transitory processor-readable storage medium having stored thereon processor-executable instructions configured to cause a processor of a computing device to perform operations comprising:
obtaining origin point coordinates via a first satellite-based navigation functionality;
obtaining termination point coordinates via a second satellite-based navigation functionality;
calculating a unit vector based on the obtained origin point coordinates and the obtained termination point coordinates;
identifying a first position, a first direction, and a first occupancy of an autonomous vehicle based on the obtained origin point coordinates, the calculated unit vector, and stored vehicle dimensions data, wherein the stored vehicle dimensions data include a length measurement and a width measurement of the autonomous vehicle, wherein the computing device is associated with the autonomous vehicle; and
transmitting a message using dedicated short-range communications (DSRC) that includes the obtained origin point coordinates, the stored vehicle dimensions data, and data for identifying the first direction of the autonomous vehicle.

24. The non-transitory processor-readable storage medium of claim 23, wherein the stored processor-executable instructions are configured to cause the processor of the computing device to perform operations further comprising:
identifying relative positions of a center point of the autonomous vehicle, the first satellite-based navigation functionality, and the second satellite-based navigation functionality; and
offsetting the obtained origin point coordinates and the obtained termination point coordinates based on the identified relative positions of the center point of the autonomous vehicle, the first satellite-based navigation functionality, and the second satellite-based navigation functionality,
wherein identifying the first position and the first occupancy of the autonomous vehicle is based on the offset obtained origin point coordinates.

25. The non-transitory processor-readable storage medium of claim 23, wherein the stored processor-executable instructions are configured to cause the processor of the computing device to perform operations further comprising:
receiving an incoming message from a nearby autonomous vehicle via the DSRC;
obtaining nearby autonomous vehicle origin point coordinates, nearby autonomous vehicle dimensions data, and data for identifying an orientation of the nearby autonomous vehicle from the received incoming message;
identifying a second position, a second direction, and a second occupancy of the nearby autonomous vehicle based on the obtained data from the received incoming message;
determining whether any navigational conditions exist based on a comparison of the first position, the first direction, and the first occupancy of the autonomous vehicle and the second position, the second direction, and the second occupancy of the nearby autonomous vehicle; and
re-configuring an autonomous control parameter in response to determining that a navigational condition exists.

26. The non-transitory processor-readable storage medium of claim 25, wherein the processor is configured with processor-executable instructions to perform operations further comprising transmitting a response message indicating the identified navigational condition.

27. The non-transitory processor-readable storage medium of claim 25, wherein the navigational condition is a risk of a collision between the autonomous vehicle and the nearby autonomous vehicle.

28. The non-transitory processor-readable storage medium of claim 25, wherein the processor is configured with processor-executable instructions to perform operations such that re-configuring the autonomous control parameter in response to determining that the navigational condition exists comprises adjusting one or more of a traversal path, a speed, and an application of brakes of the autonomous vehicle.

29. The non-transitory processor-readable storage medium of claim 25, wherein the processor is configured with processor-executable instructions to perform operations further comprising determining whether a signal strength of the incoming message exceeds a predefined threshold, and
wherein the processor is configured with processor-executable instructions to perform operations such that obtaining the nearby autonomous vehicle origin point coordinates, the nearby autonomous vehicle dimensions data, and the data for identifying the orientation of the nearby autonomous vehicle from the received incoming message comprises obtaining the nearby autonomous vehicle origin point coordinates, the nearby autonomous vehicle dimensions data, and the data for identifying the orientation of the nearby autonomous vehicle from the received incoming message in response to determining that the signal strength of the incoming message exceeds the predefined threshold.

30. A computing device, comprising:
means for obtaining origin point coordinates via a first satellite-based navigation functionality;
means for obtaining termination point coordinates via a second satellite-based navigation functionality;
means for calculating a unit vector based on the obtained origin point coordinates and the obtained termination point coordinates;
means for identifying a first position, a first direction, and a first occupancy of an autonomous vehicle based on the obtained origin point coordinates, the calculated unit vector, and stored vehicle dimensions data, wherein the stored vehicle dimensions data include a length measurement and a width measurement of the autonomous vehicle, wherein the computing device is associated with the autonomous vehicle; and
means for transmitting a message using dedicated short-range communications (DSRC) that includes the obtained origin point coordinates, the stored vehicle dimensions data, and data for identifying the first direction of the autonomous vehicle.
